(19) United States
(12) Patent Application Publication
(10) Pub. No.: US 2026/0079239 A1
(43) Pub. Date: Mar. 19, 2026

(54) RADAR DEVICE

(71) Applicant: DENSO CORPORATION, Kariya-city (JP)

(72) Inventors: SATORU SHIMIZU, Kariya-city (JP); CHIHIRO ARAI, Kariya-city (JP); YUKOU MURASE, Kariya-city (JP); OSAMU ISAJI, Kariya-city (JP)

(21) Appl. No.: 19/400,784

(22) Filed: Nov. 25, 2025

Related U.S. Application Data
(63) Continuation of application No. PCT/JP2024/019552, filed on May 28, 2024.

(30) Foreign Application Priority Data
May 31, 2023 (JP) 2023-089681

(51) Int. Cl. G01S 7/40; G01K 7/22; G01S 7/02; G01S 13/931; H01Q 1/42

(52) U.S. Cl. CPC G01S 7/4039; G01K 7/22; G01S 7/027; G01S 13/931; H01Q 1/42

(57) ABSTRACT

A radar device includes: a plurality of transmission antennas; a plurality of reception antennas; a number Ns of transmission circuits connected to the transmission antennas and outputting a transmission signal; a number Nr of reception circuits connected to the reception antennas and acquiring a reception signal; a control unit configured to process the reception signal; and a housing unit configured to house the transmission antennas, the reception antennas, the transmission circuits, the reception circuits, and the control unit. Ns and Nr are each integers of 2 or more. The plurality of transmission antennas and the plurality of reception antennas are arranged such that there are included at least Ns+Nr−2 unique sets of virtual antennas, each being a set in which a combination of a transmission circuit and a reception circuit does not overlap with other sets.

### CROSS REFERENCE TO RELATED APPLICATIONS

The present application is a continuation application of International Patent Application No. PCT/JP2024/019552 filed on May 28, 2024 which designated the U. S. and claims the benefit of priority from Japanese Patent Application No. 2023-089681 filed on May 31, 2023. The entire disclosures of all of the above applications are incorporated herein by reference.

### TECHNICAL FIELD

The present disclosure relates to radar technology.

### BACKGROUND

A related art discloses an abnormality determination method for a radar device. The radar device is provided inside the bumper of a vehicle and includes a transmission processing unit that transmits transmission waves from the inside to the outside of the bumper. The radar device includes a reception processing unit that receives object-reflected waves, which are transmission waves reflected by objects surrounding the vehicle, bumper-reflected waves, which are transmission waves reflected by the bumper, and transmission/reception leakage caused by the transmission waves, and detects objects using the object-reflected waves. The radar device includes a bumper determination unit that detects a first reception level of a first received wave including the bumper-reflected wave and the transmission/reception leakage, compares the first reception level with a threshold value, and determines that an abnormality has occurred in the bumper when the first reception level is greater than the threshold value.

### SUMMARY

According to an aspect of the present disclosure, a radar device includes: a plurality of transmission antennas; a plurality of reception antennas; a number Ns of transmission circuits connected to the transmission antennas and outputting a transmission signal; a number Nr of reception circuits connected to the reception antennas and acquiring a reception signal; a control unit configured to process the reception signal; and a housing unit configured to house the transmission antennas, the reception antennas, the transmission circuits, the reception circuits, and the control unit. Ns and Nr are each integers of 2 or more. The plurality of transmission antennas and the plurality of reception antennas may be arranged such that: (i) at least one of the plurality of transmission antennas and the plurality of reception antennas is arranged at unequal intervals; (ii) among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets; (iii) at least one different wiring length set is included, which is a set of virtual antennas with overlapping virtual positions and different wiring lengths; and (iv) a total number of belonging sets, which are sets of virtual antennas belonging to at least one of the unique sets and the different wiring length sets, is at least Ns+Nr−1 sets. The control unit may include: an error acquisition unit configured to acquire, for a plurality of reflectors, an error in at least one of phase and amplitude in at least one of between different transmitting circuits and between different receiving circuits, based on a comparison result of reflector information relating to the same reflector in the reception signals among the virtual antennas in at least Ns+Nr−1 belonging sets; a temperature acquisition unit is configured to acquire temperature information related to internal temperature of the housing unit; and a diagnosis unit is configured to, when the number of out-of-range reflectors, which are the reflectors for which the error acquired falls outside an allowable error range permitted according to the temperature information, is within an allowable upper limit number, diagnoses the out-of-range reflectors as virtual images, and when the number of the out-of-range reflectors exceeds the allowable upper limit number, diagnoses that at least one of the transmission circuit and the reception circuit has failed.

### BRIEF DESCRIPTION OF DRAWINGS

Objects, features and advantages of the present disclosure will become more apparent from the following detailed description made with reference to the accompanying drawings. In the drawings:

FIG. 1 is a schematic diagram showing the basic configuration of the radar device according to the first embodiment;

FIG. 2 is a schematic diagram illustrating examples of combinations of the transmission circuit and transmission antenna, and the receiving circuit and reception antenna in the first embodiment;

FIG. 3 is a schematic diagram showing an example of arrangement of the transmission antenna and reception antenna in the first embodiment;

FIG. 4 is a schematic diagram showing the virtual antenna assumed in the first embodiment;

FIG. 5 is a block diagram illustrating the functional configuration of the control unit according to the first embodiment;

FIG. 6 is a flowchart showing the control flow according to the first embodiment;

FIG. 7 is a flowchart showing a continuation of the control flow;

FIG. 8 is a flowchart showing a further continuation of the control flow;

FIG. 9 is a graph illustrating an example of the relationship between wiring length difference and phase error;

FIG. 10 is a graph illustrating an example of the relationship between parameters related to phase error and temperature;

FIG. 11 is a table showing an example of sets of virtual antennas used for compensation processing;

FIG. 12 is a graph showing the relationship between phase error among transmission circuits and temperature;

FIG. 13 is a graph showing the relationship between phase error among reception circuits and temperature;

FIG. 14 is a diagram for explaining phase error due to multipath;

FIG. 15 is a diagram for explaining phase error due to abnormality in the transmission/reception environment;

FIG. 16 is a graph for explaining the phase angle detected at each virtual antenna in the case of a real image peak;

FIG. 17 is a graph for explaining the phase angle detected at each virtual antenna in the case of a virtual image peak;

FIG. 18 is a graph exemplifying phase error among transmission circuits when all detected peaks are real images;

FIG. 19 is a graph exemplifying phase error among transmission circuits when some of the detected peaks are virtual images;

FIG. 20 is a graph exemplifying phase error among transmission circuits when there is an abnormality in the transmission/reception environment;

FIG. 21 is a graph exemplifying phase difference acquired by the acquisition means in the case where a failure has occurred;

FIG. 22 is a graph exemplifying phase difference acquired by the acquisition means in the case where there is a foreign matter;

FIG. 23 is a schematic diagram showing an example of arrangement of the transmission antenna and reception antenna in the second embodiment;

FIG. 24 is a schematic diagram showing the virtual antenna assumed in the second embodiment;

FIG. 25 is a schematic diagram showing an example of arrangement of the transmission antenna and reception antenna in the third embodiment;

FIG. 26 is a schematic diagram showing the virtual antenna assumed in the third embodiment;

FIG. 27 is a table showing an example of sets of virtual antennas used for compensation processing in the third embodiment;

FIG. 28 is a schematic diagram illustrating examples of combinations of the transmission circuit and transmission antenna, and the reception circuit and reception antenna in the fourth embodiment;

FIG. 29 is a schematic diagram showing an example of arrangement of the transmission antenna and reception antenna in the fourth embodiment;

FIG. 30 is a schematic diagram showing the virtual antenna assumed in the fourth embodiment;

FIG. 31 is a graph showing the relative relationship of wiring lengths among virtual antennas assumed in the fourth embodiment; and

FIG. 32 is a table showing an example of sets of virtual antennas used for compensation processing in the fifth embodiment.

### DETAILED DESCRIPTION

Incidentally, in a radar device, abnormalities other than bumper abnormalities and transmission/reception leakage as described in the related art may also occur. Specifically, in a radar device, there is a possibility that abnormalities such as multipath and failure of the radar device may arise. The related art does not disclose a method for distinguishing such abnormalities.

The present disclosure provides a radar device capable of distinguishing between multipath and failure.

According to one aspect of the present disclosure, a radar device includes: a plurality of transmission antennas; a plurality of reception antennas; a number Ns of transmission circuits connected to the transmission antennas and outputting a transmission signal; a number Nr of reception circuits connected to the reception antennas and acquiring a reception signal; a control unit configured to process the reception signal; and a housing unit configured to house the transmission antennas, the reception antennas, the transmission circuits, the reception circuits, and the control unit. Ns and Nr are each integers of 2 or more. The plurality of transmission antennas and the plurality of reception antennas are arranged such that: (i) at least one of the plurality of transmission antennas and the plurality of reception antennas is arranged at unequal intervals; (ii) among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets; (iii) at least one different wiring length set is included, which is a set of virtual antennas with overlapping virtual positions and different wiring lengths; and (iv) a total number of belonging sets, which are sets of virtual antennas belonging to at least one of the unique sets and the different wiring length sets, is at least Ns+Nr−1 sets. The control unit includes: an error acquisition unit configured to acquire, for a plurality of reflectors, an error in at least one of phase and amplitude in at least one of between different transmitting circuits and between different receiving circuits, based on a comparison result of reflector information relating to the same reflector in the reception signals among the virtual antennas in at least Ns+Nr−1 belonging sets; a temperature acquisition unit is configured to acquire temperature information related to internal temperature of the housing unit; and a diagnosis unit is configured to, when the number of out-of-range reflectors, which are the reflectors for which the error acquired falls outside an allowable error range permitted according to the temperature information, is within an allowable upper limit number, diagnoses the out-of-range reflectors as virtual images, and when the number of the out-of-range reflectors exceeds the allowable upper limit number, diagnoses that at least one of the transmission circuit and the reception circuit has failed.

According to one aspect of the present disclosure, a radar device includes: a plurality of transmission antennas arranged at equal intervals; a plurality of reception antennas arranged at equal intervals; a number Ns of transmission circuits connected to the transmission antennas and outputting a transmission signal; a number Nr of reception circuits connected to the reception antennas and acquiring a reception signal; a control unit configured to process the reception signal; and a housing unit configured to house the transmission antennas, the reception antennas, the transmission circuits, the reception circuits, and the control unit. Ns and Nr are each integers of 2 or more. The plurality of transmission antennas and the plurality of reception antennas are arranged such that: (i) among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets; (ii) at least one different wiring length set is included, which is a set of virtual antennas with overlapping virtual positions and different wiring lengths; and (iii) a total number of belonging sets, which are sets of virtual antennas belonging to at least one of the unique sets and the different wiring length sets, is at least Ns+Nr−1 sets. The control unit includes: an error acquisition unit configured to acquire, for a plurality of reflectors, an error in at least one of phase and amplitude in at least one of between different transmitting circuits and between different receiving circuits, based on a comparison result of reflector information relating to the same reflector in the reception signals among the virtual antennas in at least Ns+Nr−1 belonging sets; a temperature acquisition unit is configured to acquire temperature information related to internal temperature of the housing unit; and a diagnosis unit is configured to, when the number of out-of-range reflectors, which are the reflectors for which the error acquired falls outside an allowable error range permitted according to the temperature information, is within an allowable upper limit number, diagnoses the out-of-range reflectors as virtual images, and when the number of the out-of-range reflectors exceeds the allowable upper limit number, diagnoses that at least one of the transmission circuit and the reception circuit has failed.

According to one aspect of the present disclosure, a radar device includes: a plurality of transmission antennas; a plurality of reception antennas; a number Ns of transmission circuits connected to the transmission antennas and outputting a transmission signal; a number Nr of reception circuits connected to the reception antennas and acquiring a reception signal; a control unit configured to process the reception signal; and a housing unit configured to house the transmission antennas, the reception antennas, the transmission circuits, the reception circuits, and the control unit. Ns and Nr are each integers of 2 or more. The plurality of transmission antennas and the plurality of reception antennas are arranged such that: (i) at least one of the plurality of transmission antennas and the plurality of reception antennas is arranged at unequal intervals; and (ii) among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets. The control unit includes: an error acquisition unit configured to acquire, for a plurality of reflectors, an error in at least one of phase and amplitude in at least one of between different transmitting circuits and between different receiving circuits, based on a comparison result of reflector information relating to the same reflector in the reception signals among the virtual antennas in at least Ns+Nr−2 unique sets; a temperature acquisition unit is configured to acquire temperature information related to internal temperature of the housing unit; and a diagnosis unit is configured to, when the number of out-of-range reflectors, which are the reflectors for which the error acquired falls outside an allowable error range permitted according to the temperature information, is within an allowable upper limit number, diagnoses the out-of-range reflectors as virtual images, and when the number of the out-of-range reflectors exceeds the allowable upper limit number, diagnoses that at least one of the transmission circuit and the reception circuit has failed.

According to one aspect of the present disclosure, a radar device includes: a plurality of transmission antennas arranged at equal intervals; a plurality of reception antennas arranged at equal intervals; a number Ns of transmission circuits connected to the transmission antennas and outputting a transmission signal; a number Nr of reception circuits connected to the reception antennas and acquiring a reception signal; a control unit configured to process the reception signal; and a housing unit configured to house the transmission antennas, the reception antennas, the transmission circuits, the reception circuits, and the control unit. Ns and Nr are each integers of 2 or more. The plurality of transmission antennas and the plurality of reception antennas are arranged such that, among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets. The control unit includes: an error acquisition unit configured to acquire, for a plurality of reflectors, an error in at least one of phase and amplitude in at least one of between different transmitting circuits and between different receiving circuits, based on a comparison result of reflector information relating to the same reflector in the reception signals among the virtual antennas in at least Ns+Nr−2 unique sets; a temperature acquisition unit is configured to acquire temperature information related to internal temperature of the housing unit; and a diagnosis unit is configured to, when the number of out-of-range reflectors, which are the reflectors for which the error acquired falls outside an allowable error range permitted according to the temperature information, is within an allowable upper limit number, diagnoses the out-of-range reflectors as virtual images, and when the number of the out-of-range reflectors exceeds the allowable upper limit number, diagnoses that at least one of the transmission circuit and the reception circuit has failed.

According to these embodiments, when the number of out-of-range reflectors, which are reflectors for which an error outside the allowable error range permitted according to the temperature information has been acquired, falls within the allowable upper limit number, it is diagnosed that the out-of-range reflectors are virtual images. When the number of out-of-range reflectors exceeds the allowable upper limit number, it is possible to diagnose that at least one of the transmission circuit and the reception circuit has failed. Accordingly, it becomes possible to distinguish between multipath and failure.

Hereinafter, embodiments of the present disclosure will be described in detail with reference to the drawings. In addition, corresponding components in each embodiment are denoted by the same reference numerals, and redundant explanations may be omitted. Further, in cases where only a part of a configuration is described in each embodiment, other parts of the configuration may be applied from the configurations described in other preceding embodiments. Furthermore, not only the combinations of configurations explicitly described in the explanations of each embodiment, but also, unless there is a particular hindrance to such combinations, configurations of multiple embodiments may be partially combined with each other even if not explicitly stated.

### First Embodiment

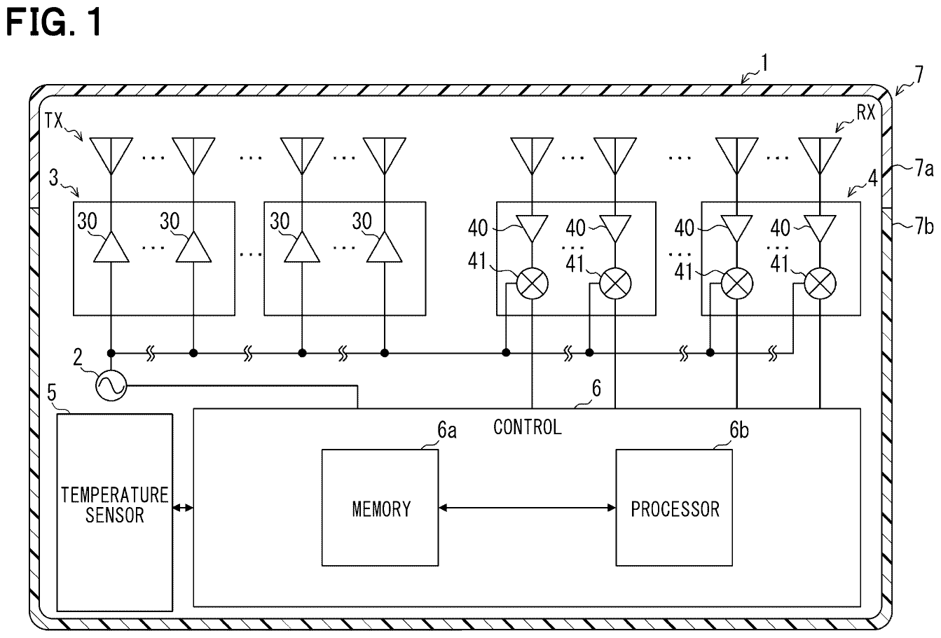

The first embodiment of the present disclosure will be described below with reference to FIG. 1 to FIG. 22. The radar device 1 is mounted, for example, on a mobile body such as a vehicle. The radar device 1 transmits a transmission signal, receives the transmission signal reflected by an object as a reception signal, and detects, as target information, the distance to the target, which is an object that reflected the transmission signal, the relative speed with respect to the target, the direction of the target, and the like.

The target information output from the radar device 1 is input to an in-vehicle ECU (Electronic Control Unit) via an in-vehicle network such as CAN (Control Area Network, registered trademark) and Ethernet (registered trademark). The in-vehicle ECU executes various processes for autonomous driving and advanced driver assistance of the vehicle, based on the acquired target information for each target.

Examples of processing based on target information include collision avoidance processing and warning processing. Collision avoidance processing is a process for controlling the vehicle to avoid collision with a target by controlling the brake system, steering system, and the like based on the target information for each target. Warning processing is a process for warning the driver of the possibility of collision with a target based on the target information for each target.

As shown in the basic configuration of FIG. 1, the radar device 1 of this embodiment includes an oscillator 2, a plurality of transmission circuits 3, a plurality of transmission antennas TX, a plurality of reception antennas RX, a plurality of reception circuits 4, a temperature sensor 5, a control unit 6, and a housing unit 7. The radar device 1 is a so-called MIMO (Multiple-Input-Multiple-Output) radar, which transmits transmission signals from a plurality of transmission antennas TX to pseudo-increase (that is, virtually increase) the number of reception antennas RX beyond the actual number.

The oscillator 2 acquires a control signal from the control unit 6 and generates a modulated signal modulated according to the control signal. The modulated signal is, for example, a so-called chirp signal whose frequency changes over time. The modulated signal is distributed and output to each channel of the transmission circuit 3 and the reception circuit 4. Hereinafter, the modulated signal output from the oscillator 2 to the transmission circuit 3 is referred to as the transmission signal. The modulated signal output from the oscillator 2 to the reception circuit 4 is referred to as the local signal.

The transmission circuit 3 and the reception circuit 4 are mainly configured with semiconductor integrated circuit devices such as MMIC (Monolithic Microwave Integrated Circuit). The transmission circuit 3 is connected to the transmission antenna TX and outputs the transmission signal to the transmission antenna TX. If the number of transmission circuits 3 mounted in one radar device 1 is Ns, Ns is an integer of 2 or more. The transmission circuit 3 includes the same number of amplifiers 30 as the connected transmission antennas TX. The amplifier 30 amplifies the transmission signal output from the oscillator 2 and outputs it to the corresponding transmission antenna TX.

The transmission antenna TX converts the electrical signal supplied from the oscillator 2 as the transmission signal into a radio wave signal and transmits it to the outside. The transmission antenna TX is configured to include at least one or more antenna elements. For example, the transmission antenna TX is a patch antenna provided with a plurality of flat plate-shaped antenna elements. The antenna element is arranged on the surface opposite to the ground plate on the dielectric substrate, with the ground plate provided on one side. The plurality of antenna elements are, for example, connected in series by a feed line that supplies the electrical signal.

The reception antenna RX receives, as a reception signal, a radio wave signal including the transmission signal reflected by a target serving as a reflector (also referred to as a reflection object) in the external environment. The reception antenna RX is connected to the corresponding reception circuit 4. The arrangement of the transmission antenna TX and the reception antenna RX will be described later.

The reception antenna RX converts the reception signal, which is a radio wave signal, into an electrical signal and outputs it to the corresponding reception circuit 4. The reception antenna RX, similarly to the transmission antenna TX, is, for example, a patch antenna in which at least one antenna element is connected in series by a feed line.

The reception circuit 4 is connected to the reception antenna RX and acquires the reception signal received by the reception antenna RX. Let Nr be the number of reception circuits 4 installed in one radar device 1; Nr is an integer of 2 or more. The reception circuit 4 includes the same number of amplifiers 40 and signal mixing units 41 as the connected reception antennas RX.

The amplifier 40 amplifies the reception signal received by the reception antenna and outputs it to the signal mixing unit 41. The signal mixing unit 41 generates a beat signal by mixing the local signal from the oscillator 2 and the reception signal. The generated beat signal is an interference signal representing the frequency difference between the reception signal and the local signal. The beat signal, with high-frequency components outside the frequency difference between the reception signal and the local signal removed by a low-pass filter (not shown), is output to the control unit 6 as signal data related to the reception signal.

The temperature sensor 5 detects the temperature inside the radar device 1. The temperature sensor 5 includes, for example, a thermistor and outputs temperature information corresponding to the resistance value of the thermistor. The temperature sensor 5 detects the temperature information of each transmission circuit 3 and reception circuit 4 and outputs it to the control unit 6.

The housing unit 7 is a housing that accommodates the transmission antenna TX, reception antenna RX, oscillator 2, transmission circuit 3, reception circuit 4, temperature sensor 5, and control unit 6. The housing unit 7 includes a radome 7a and a case body 7b. The radome 7a is mainly formed of a transmission material that transmits millimeter-wave radio waves. The radome 7a is attached to the case body 7b so as to cover the antennas TX, RX. While protecting the antennas TX and RX, the radome 7a also enables the transmission and reception of signals at the antennas TX and RX by allowing radio waves to pass through. The case body 7b, together with the radome 7a, forms a housing space that accommodates the above-mentioned components of the radar device 1.

The control unit 6 is a control unit configured to include at least one dedicated computer. The dedicated computer constituting the control unit 6 may be, for example, an ECU (Electronic Control Unit) specialized for controlling the radar device 1.

The dedicated computer constituting the control unit 6 includes at least one memory 6a and at least one processor 6b. The memory 6a is a non-transitory tangible storage medium, such as a semiconductor memory, magnetic medium, or optical medium, which non-transitorily stores programs and data readable by the computer. Here, storage may refer to accumulation in which data is retained even when the sensor system is powered off, or temporary storage in which data is erased when the sensor system is powered off. The processor 6b may include at least one core selected from, for example, a CPU (Central Processing Unit), GPU (Graphics Processing Unit), RISC-CPU (Reduced Instruction Set Computer), DFP (Data Flow Processor), and GSP (Graph Streaming Processor). Alternatively, the processor 6b may be at least one of a digital circuit or an analog circuit. Here, the digital circuit may be at least one selected from, for example, ASIC (Application Specific Integrated Circuit), FPGA (Field Programmable Gate Array), SoC (System on a Chip), PGA (Programmable Gate Array), and CPLD (Complex Programmable Logic Device). Such digital circuits may also include a memory 6a in which programs are stored.

The control unit 6 executes angle measurement processing to calculate the angle of a reflector with respect to the radar device 1 by processing a plurality of beat signals output from the plurality of reception circuits 4. The radar device 1 achieves relatively high angular resolution by virtually increasing the number of effective reception antennas RX beyond the actual number through the use of the MIMO method. In addition, the control unit 6 achieves relatively high angle measurement accuracy by executing compensation processing to compensate for phase difference and amplitude difference of signals occurring between different transmission circuits 3 and between different reception circuits 4.

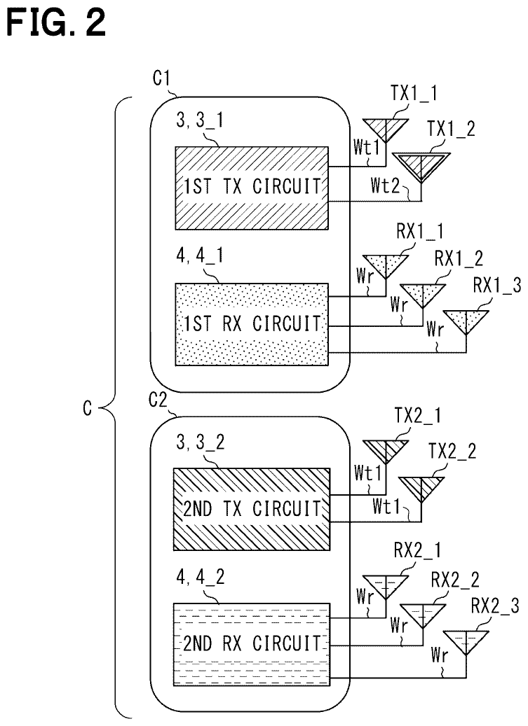

For the above compensation processing, each transmission antenna TX and reception antenna RX is implemented in a prescribed arrangement. The arrangement of the transmission antenna TX and reception antenna RX will be described below with reference to specific examples shown in FIG. 2 to FIG. 4.

By using a plurality of transmission antennas TX and a plurality of reception antennas RX, for each transmission antenna TX, a plurality of virtual antennas V can be considered for each reception antenna RX, based on the phase differences of the reception signals between the reception antennas RX. The virtual position of each virtual antenna V is defined by the relative position of the corresponding transmission antenna TX with respect to other transmission antennas TX, and the relative position of the corresponding reception antenna RX with respect to other reception antennas RX.

The transmission antennas TX and reception antennas RX are arranged so that the number of unique sets is at least Ns+Nr−2 sets. Here, a unique set is a set of virtual antennas V whose virtual positions overlap among the groups of virtual antennas V assumed for each transmission antenna TX. Furthermore, a unique pair is defined, among the collection of the sets of virtual antennas in which the combinations of transmission circuits 3 and reception circuits 4 do not coincide, as a set of virtual antennas in which the combination of the transmission circuit 3 and the reception circuit 4 does not overlap with that of any other pair.

As an example, consider a radar device 1 in which four transmission antennas TX and six reception antennas RX are implemented. In this example, the number of transmission circuits 3 is Ns=2, and the number of reception circuits 4 is Nr=2. In this case, as shown in FIG. 2, the number of channels in one transmission circuit 3 is at least two. The number of channels in one reception circuit 4 is at least three. Hereinafter, one of the transmission circuits 3 is referred to as the first transmission circuit 3_1, and the other as the second transmission circuit 3_2. Similarly, one of the reception circuits 4 is referred to as the first reception circuit 4_1, and the other as the second reception circuit 4_2. In this embodiment, each circuit is implemented on a plurality of circuit chips C. Specifically, the first transmission circuit 3_1 and the first reception circuit 4_1 are implemented on the same first circuit chip C1. The second transmission circuit 3_2 and the second reception circuit 4_2 are implemented on the same second circuit chip C2.

Furthermore, in the radar device 1 of this embodiment, at least one transmission antenna TX has a wiring length different from that of the other transmission antennas TX. In the example shown in FIG. 2, the wiring Wt2 of the transmission antenna TX1_2 connected to the first transmission circuit 3_1 is longer than the wiring Wt1 of the other transmission antennas TX. The wiring length of each wiring Wr of the reception antennas RX is assumed to be substantially the same. Furthermore, the transmission antennas TX and reception antennas RX are arranged so that the wiring length difference between virtual antennas in the belonging set described later falls within the allowable difference range.

Hereinafter, the four transmission antennas TX and six reception antennas RX may be distinguished by assigning different reference numerals to each. Specifically, the two transmission antennas TX connected to the first transmission circuit 3_1 are referred to as transmission antennas TX1_1 and TX1_2, and the two transmission antennas TX connected to the second transmission circuit 3_2 are referred to as transmission antennas TX2_1 and TX2_2. The three reception antennas RX connected to the first reception circuit 4_1 are referred to as reception antennas RX1_1, RX1_2, RX1_3, and the three reception antennas RX connected to the second reception circuit 4_2 are referred to as reception antennas RX2_1, RX2_2, RX2_3.

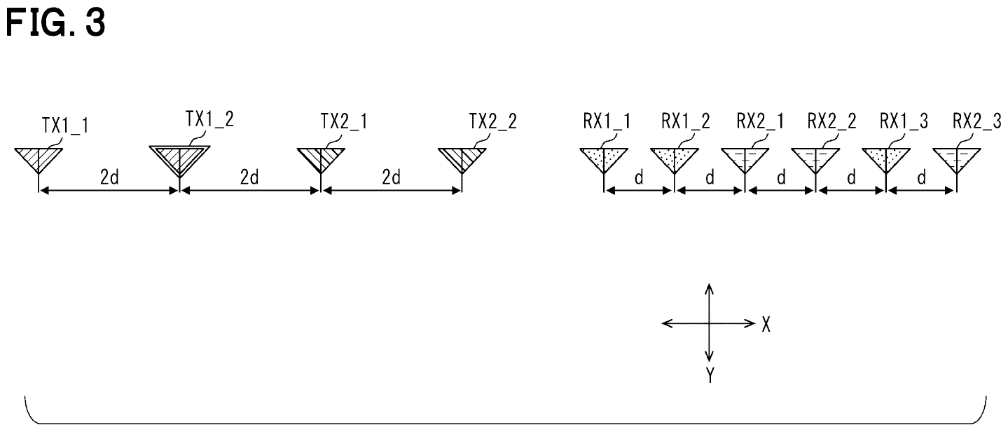

In the example shown in FIG. 3, the transmission antennas TX1_1, TX1_2, TX2_1, and TX2_2 are arranged in the X direction, which serves as the reference direction, from one side to the other in this order, at intervals of 2d. Furthermore, the reception antennas RX1_1, RX1_2, RX2_1, RX2_2, RX2_3, and RX1_3 are arranged in the X direction from one side to the other in this order, at intervals of d.

When antennas with different wiring lengths are present, the transmission antennas TX and reception antennas RX are arranged so that the number of unique sets is at least Ns+Nr−2 sets, that is, two sets. In this embodiment, the transmission antennas TX and reception antennas RX are each arranged at equal intervals in a one-dimensional manner. Here, “one-dimensional arrangement” means that they are arranged in a row along a single reference direction.

For each transmission antenna TX1_1, TX1_2, TX2_1, and TX2_2, six virtual antennas V are assumed corresponding to the number of reception antennas RX. Therefore, a total of 24 virtual antennas V are assumed.

Hereinafter, the plurality of virtual antennas V assumed for transmission antenna TX1_1, arranged from one side to the other, are referred to as virtual antennas V1, V2, V3, V4, V5, and V6. The plurality of virtual antennas V assumed for transmission antenna TX1_2 from one side to the other are referred to as virtual antennas V7, V8, V9, V10, V11, and V12. Furthermore, the group of virtual antennas V assumed for transmission antenna TX2_1 from one side to the other are referred to as virtual antennas V13, V14, V15, V16, V17, and V18. The group of virtual antennas V assumed for transmission antenna TX2_2 from one side to the other are referred to as virtual antennas V19, V20, V21, V22, V23, and V24.

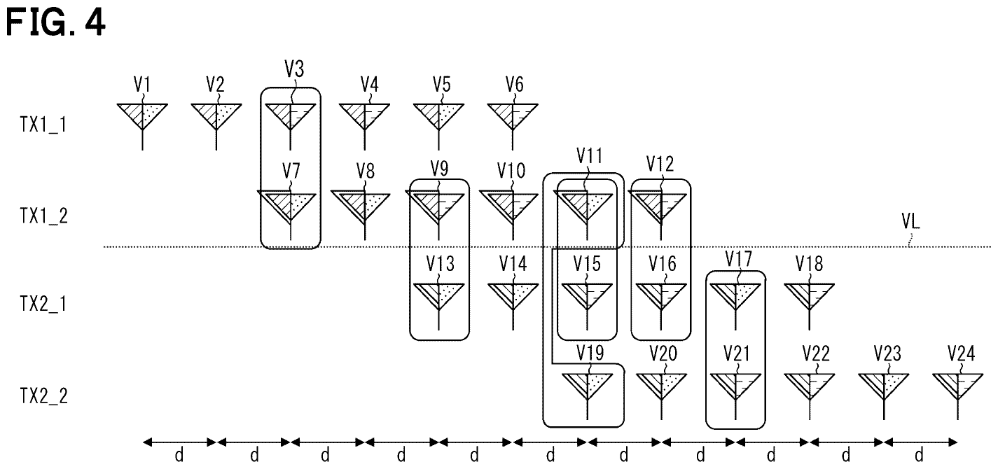

Since adjacent transmission antennas TX are arranged at intervals of 2d, the plurality of virtual antennas V assumed for a particular transmission antenna TX will have virtual positions that are relatively shifted by 2d from the plurality of virtual antennas V assumed for an adjacent transmission antenna TX. As the reception antennas RX are arranged at intervals of d, as shown in FIG. 4, there are 16 sets of virtual antennas V whose virtual positions overlap. Note that, for clarity in FIG. 4, the virtual positions of the plurality of virtual antennas V for each transmission antenna TX are depicted shifted in the vertical direction of the page. In actuality, the plurality of virtual antennas V are assumed to have their respective virtual positions on a virtual line VL extending in the reference direction (X direction). That is, in FIG. 4, virtual antennas V with the same left-right position on the page constitute sets of virtual antennas V with overlapping virtual positions. Hereinafter, specific sets of virtual antennas V with overlapping virtual positions are denoted as Vn and Vm, where n and m represent natural numbers assigned to each individual virtual antenna V.

Specifically, the following sets constitute sets of virtual antennas V with overlapping virtual positions: (V3, V7), (V4, V8), (V5, V9), (V5, V13), (V6, V10), (V6, V14), (V9, V13), (V10, V14), (V11, V15), (V11, V19), (V12, V16), (V12, V20), (V15, V16), (V16, V20), (V17, V21), and (V18, V22).

Among the above sets, the group of virtual antennas V as a collection in which the combination of transmission circuit 3 and reception circuit 4 does not match between the virtual antennas V in the set includes 14 sets, excluding (V6, V10) and (V18, V22). Among this group of virtual antennas V, the number of sets in which the combination of transmission circuit 3 and reception circuit 4 does not overlap with other sets is six, thus satisfying the condition of at least Ns+Nr−2 sets. One example of these six sets is as follows: (V3, V7), (V9, V13), (V11, V15), (V11, V19), (V12, V16), and (V17, V21).

Furthermore, the transmission antennas TX and reception antennas RX are arranged so that at least one set of different wiring length sets is included. A different wiring length set is a set of virtual antennas V with overlapping virtual positions and differing wiring lengths. The transmission antennas TX and reception antennas RX are arranged so that the total number of belonging sets is at least Ns+Nr−1. Here, a belonging set refers to a set of virtual antennas V that belongs to at least one of the above-mentioned unique sets or sets with different wiring lengths (also referred to as different wiring length sets).

The example of six sets described above includes different wiring length sets. That is, among these six sets, five sets except for (V17, V21) are different wiring length sets, thus satisfying the condition of at least one set. Accordingly, the total number of belonging sets is six, satisfying the condition of at least Ns+Nr−1 sets.

Note that, as long as the combination of transmission circuit 3 and reception circuit 4 does not overlap with other sets, sets of virtual antennas V assumed for compensation processing may be other than the above-mentioned sets. For example, (V4, V8) and (V5, V9) have the same combination of transmission circuit 3 and reception circuit 4 as (V3, V7), but do not overlap with other sets. Therefore, considering (V4, V8) or (V5, V9) as one of the six sets is equivalent to considering (V3, V7) as one of the six sets.

Note that, if the control unit 6 secures at least Ns+Nr−2 sets of virtual antennas V whose combination of transmission circuit 3 and reception circuit 4 does not overlap with other sets, additional sets whose combination of transmission circuit 3 and reception circuit 4 does overlap with other sets may also be assumed as sets to be used for compensation processing.

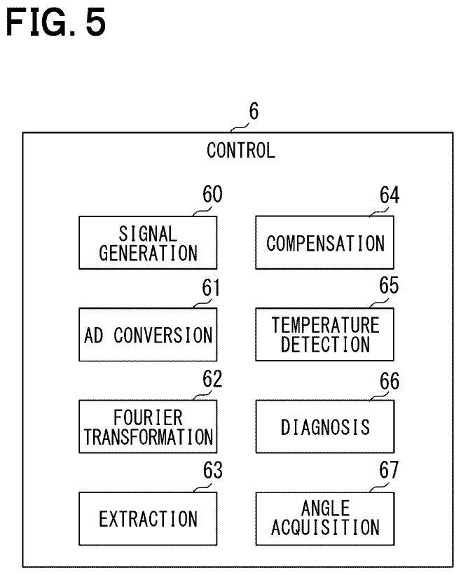

For the above compensation processing and control of the radar device 1, the processor 6b executes a plurality of instructions included in a control program stored in the memory 6a. As a result, the control unit 6 constructs functional units for controlling the radar device 1. Specifically, as shown in FIG. 5, the control unit 6 constructs, as functional units, a signal generation unit 60, an AD conversion unit 61, a Fourier transform unit 62, an extraction unit 63, a compensation unit 64, a temperature detection unit 65, a diagnosis unit 66, and an angle acquisition unit 67.

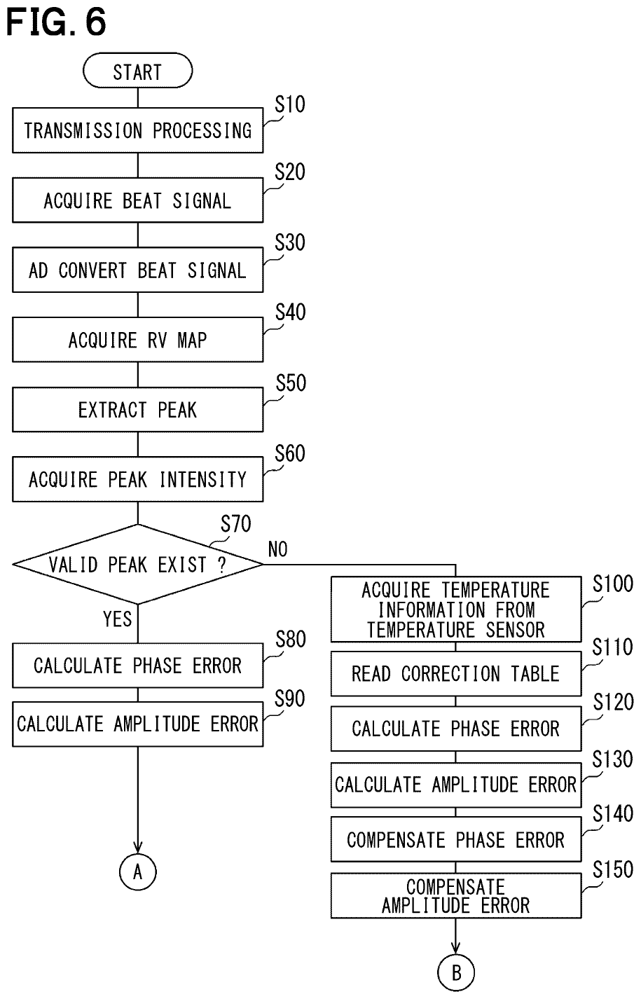

By means of these functions of the processor 6b, the radar control method for controlling the radar device 1 by the control unit 6 is executed according to the control flow shown in FIG. 6 to FIG. 8. This control flow is repeatedly executed while the vehicle is in operation. Note that each “S” in this control flow denotes a plurality of steps executed by a plurality of instructions included in the control program.

First, in S10 of FIG. 6, the signal generation unit 60 outputs a transmission signal from the oscillator 2. In the subsequent S20, the AD conversion unit 61 acquires, from the reception circuit 4, a beat signal corresponding to the reception signal received by the reception antenna RX after the transmission signal transmitted from the transmission antenna TX to the external environment is reflected by the target. In S30, the AD conversion unit 61 converts the beat signal into a digital signal by performing A/D conversion processing that samples the beat signal at predetermined time intervals. In the subsequent S40, the Fourier transform unit 62 executes FFT (Fast Fourier Transform) processing for each chirp of the A/D converted beat signal. As a result, the Fourier transform unit 62 acquires, for each chirp, a frequency spectrum (distance spectrum) that shows a peak at the frequency position corresponding to the distance to the target. The distance spectrum is data indicating the signal intensity for each distance bin according to the distance resolution.

Then, the Fourier transform unit 62 executes FFT processing on the distance spectrum. That is, the Fourier transform unit 62 performs a second FFT processing on the waveform in which the phase at each distance bin obtained by the first FFT processing for multiple chirps is arranged in time series. As a result, a frequency spectrum (velocity spectrum) showing a peak at the position corresponding to the relative velocity with the target is obtained for each velocity bin. Through this two-dimensional FFT, the Fourier transform unit 62 acquires two-dimensional information (RV map) showing a peak at the position corresponding to the distance to the target and the relative velocity of the target. The information about the acquired peaks is an example of “reflector information.”

Next, in S50, the extraction unit 63 extracts peaks from the RV map. In the subsequent S60, the extraction unit 63 acquires the intensity of the extracted peaks. Then, in S70, the extraction unit 63 determines whether the extracted peaks are valid. For example, the extraction unit 63 determines that a peak is valid when its intensity is within the allowable intensity range. Here, the allowable intensity range is a range where the intensity is equal to or greater than a predetermined threshold value, or greater than the threshold value. If it is determined that a valid peak exists, the flow proceeds to S80.

In S80, the compensation unit 64 acquires phase errors between transmission circuits 3, between reception circuits 4, and according to the wiring length differences of the virtual antennas V, based on the phase of valid peaks in each virtual channel. Here, the wiring length of a virtual antenna V refers to the total wiring length from the corresponding transmission antenna TX to the transmission circuit 3 and from the corresponding reception antenna RX to the reception circuit 4. In this case, since only the wiring Wt2 is longer than wiring Wt1, and all wirings Wr of the reception antennas RX are substantially equal in length, the wiring length of the virtual antennas V assumed for transmission antenna TX1_2 becomes longer than that of the virtual antennas V assumed for the other transmission antennas TX.

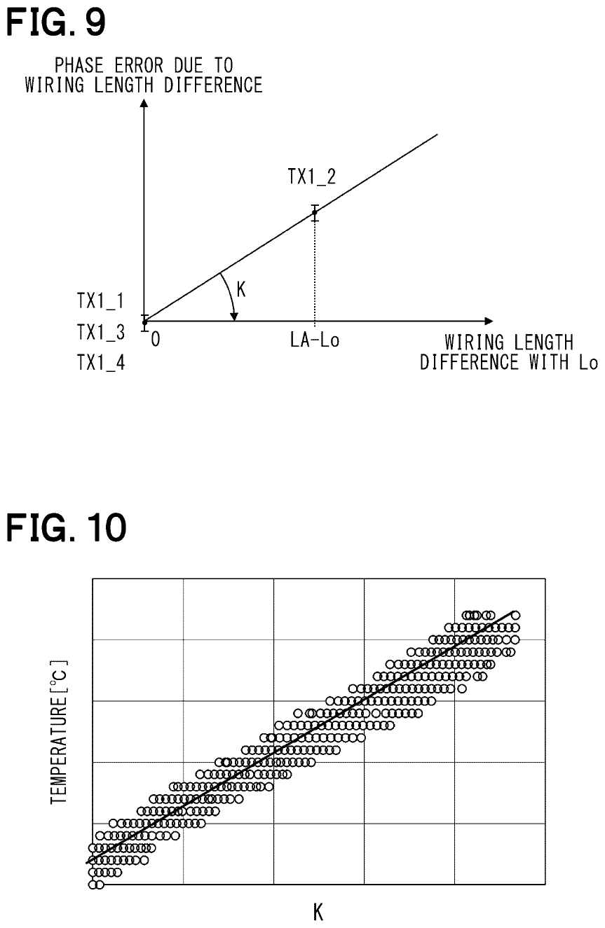

Generally, as shown in FIG. 9, the phase error due to the wiring length difference for each virtual antenna V increases linearly according to the wiring length difference relative to a reference wiring length Lo (for example, the shortest wiring length). That is, the phase error with respect to the wiring length difference is a value obtained by multiplying the wiring length difference by a parameter K. Therefore, as shown in FIG. 9, the parameter K corresponds to the slope of the graph of phase error versus wiring length difference. Thus, if the wiring length of the virtual antenna V assumed for transmission antenna TX1_2 is LA, the parameter K can be calculated from the wiring length difference LA−Lo. In this case, the reference wiring length Lo is the wiring length at room temperature of the virtual antennas V assumed for transmission antennas TX other than TX1_2.

The parameter K is a parameter corresponding to the value obtained by multiplying the linear expansion coefficient of the wiring by the temperature of the wiring. Since the linear expansion coefficient of an object does not depend on temperature, the parameter K is a parameter that varies with temperature. As shown in FIG. 10, the parameter K increases linearly as the temperature increases.

In the phase compensation processing, the compensation unit 64 defines a linear equation for each of at least Ns+Nr−1 belonging sets of virtual antennas V, based on the phase difference of the peaks in the beat signal. In this linear equation, the relative phase errors between transmission circuits 3, between reception circuits 4, and the relative phase error according to the wiring length difference are defined as unknowns. The compensation unit 64 acquires the solution to this linear equation as the relative phase error. Since the beat signal is a signal related to the reception signal, the phase difference of the peaks in the beat signal is an example of a comparison result of the reception signals between virtual antennas V.

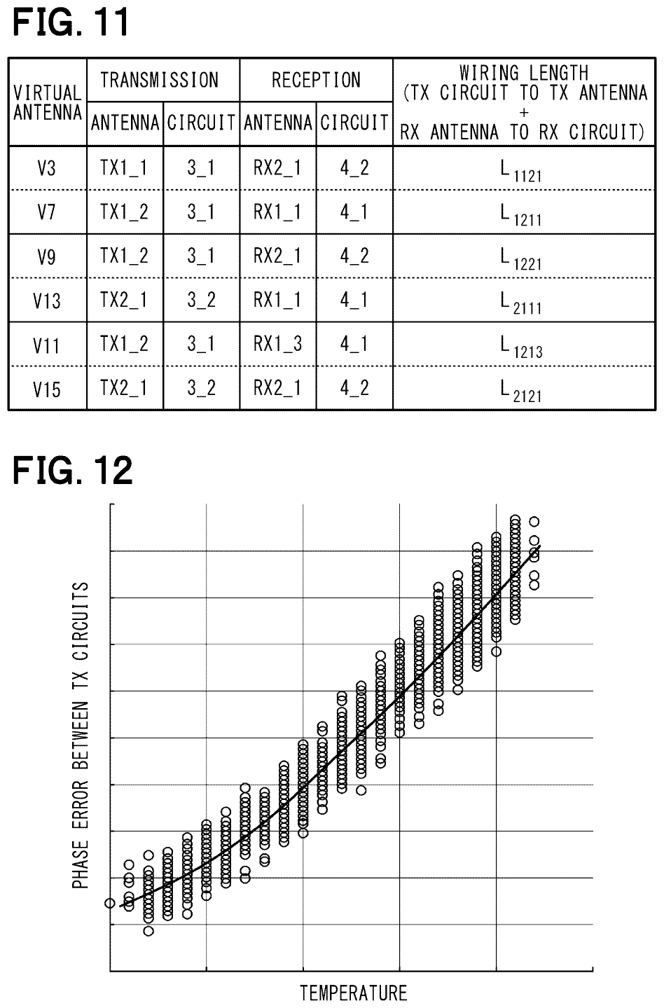

The acquisition of the relative phase error is described in detail below. In the following description, the phase at the peak of the beat signal corresponding to virtual antenna Vn is denoted as θ_{Vn} (where n is a natural number). The wiring length difference in the virtual antenna V assumed for the combination of transmission antenna TXa_b and reception antenna RXc_d is denoted as L_{abij} (where a, b, i, j are natural numbers). For simplicity, in the following description, three belonging sets are used: (V3, V7), (V9, V13), and (V11, V15), as shown in FIG. 11. Let the phase error due to the wiring length difference L_{abij} be e_{abij}. In the example shown in FIG. 11, the phase difference of the peaks θ_{V3}-θ_{V7} for (V3, V7) can be defined by the relationship shown in Equation (1). The phase difference of the peaks θ_{V9}-θ_{V13} for (V9, V13) can be defined by the relationship shown in Equation (2). Furthermore, the phase difference of the peaks θ_{V11}-θ_{V15} for (V11, V15) can be defined by the relationship shown in Equation (3).

$$( Equation 1 )$$

$${θ}_{V 3} - {θ}_{V 7} = ( {Θ}_{a} + {e}_{tx 1} + {e}_{rx 2} + {e}_{1121} ) - ( {Θ}_{a} + {e}_{tx 1} + {e}_{rx 1} + {e}_{1211} ) \qquad ( 1 )$$

$$( Equation 2 )$$

$${θ}_{V 9} - {θ}_{V 13} = ( {Θ}_{b} + {e}_{tx 1} + {e}_{rx 2} + {e}_{1221} ) - ( {Θ}_{b} + {e}_{tx 2} + {e}_{rx 1} + {e}_{1211} ) \qquad ( 2 )$$

$$( Equation 3 )$$

$${θ}_{V 11} - {θ}_{V 15} = ( {Θ}_{c} + {e}_{tx 1} + {e}_{rx 1} + {e}_{1213} ) - ( {Θ}_{c} + {e}_{tx 2} + {e}_{rx 2} + {e}_{2121} ) \qquad ( 3 )$$

In the above equations, θₐ, θ_{b}, and θ_{c} are phase errors caused by the target. eₜₓ₁ is the phase error of the signal occurring in the first transmission circuit 3_1. eₜₓ₂ is the phase error of the signal occurring in the second transmission circuit 3_2. eᵣₓ₁ is the phase error of the signal occurring in the first reception circuit 4_1. eᵣₓ₂ is the phase error of the signal occurring in the second reception circuit 4_2.

Here, in phase compensation, it is sufficient to consider the relative phase error between transmission circuits 3 and the relative phase error between reception circuits 4. Therefore, the relative phase error of the second transmission circuit 3_2 with respect to the first transmission circuit 3_1, and the relative phase error of the second reception circuit 4_2 with respect to the first reception circuit 4_1, are considered. In this case, eₜₓ₁ and eᵣₓ₁ can be set to zero. If the phase error e_{abij} is replaced with L_{abij}·K, the above equations 1 to 3 can be transformed into the following equations 4 to 6:

$$( Equation 4 )$$

$${θ}_{V 3} - {θ}_{V 7} = {e}_{r x 2} + ( {L}_{1121} - {L}_{1211} ) \cdot K \qquad ( 4 )$$

$$( Equation 5 )$$

$${θ}_{V 9} - {θ}_{V 13} = - {e}_{tx 2} + {e}_{r x 2} + ( {L}_{1221} - {L}_{2111} ) \cdot K \qquad ( 5 )$$

$$( Equation 6 )$$

$${θ}_{V 11} - {θ}_{V 15} = - {e}_{tx 2} - {e}_{r x 2} + ( {L}_{1213} - {L}_{2121} ) \cdot K \qquad ( 6 )$$

When this is converted into matrix form, the phase differences of each set and the relative phase errors satisfy the relationship expressed by the following Equation (7):

$$( Equation 7 )$$

$$( \begin{matrix}{θ}_{V 3} - {θ}_{V 7} \\ {θ}_{V 9} - {θ}_{V 13} \\ {θ}_{V 11} - {θ}_{V 15}\end{matrix} ) = ( \begin{matrix}0 & 1 & {L}_{1121} - {L}_{1211} \\ - 1 & 1 & {L}_{1221} - {L}_{2111} \\ - 1 & - 1 & {L}_{1213} - {L}_{2121}\end{matrix} ) \cdot ( \begin{matrix}{e}_{tx 2} \\ {e}_{rx 2} \\ K\end{matrix} ) \qquad ( 7 )$$

Here, the term on the left side of Equation (7) is the phase difference vector Y3 between overlapping virtual antennas V. The first term on the right side of Equation (7) is the coefficient matrix A3. The second term is the phase error vector X3. The phase difference vector Y3 in Equation (7) can be calculated from the peak phase of each beat signal. The coefficient matrix A3 is a constant matrix defined by the combination of transmission circuit 3, reception circuit 4, and wiring length difference for each set of virtual antennas V. Therefore, Equation (7) can be solved as a system of simultaneous equations with eₜₓ₂, eᵣₓ₂, and K as unknowns. That is, the compensation unit 64 acquires eₜₓ₂, eᵣₓ₂, and K as the solution to Equation (7), as the relative phase error of the second transmission circuit 3_2 with respect to the first transmission circuit 3_1, the relative phase error of the second reception circuit 4_2 with respect to the first reception circuit 4_1, and the relative phase error according to the wiring length difference. The compensation unit 64 is an example of an “error acquisition unit,” and the relative phase error is an example of “error information.”

In the subsequent S90, the compensation unit 64 acquires amplitude errors between transmission circuits 3, between reception circuits 4, and amplitude errors according to wiring length differences, based on the amplitude of valid peaks in each virtual antenna V.

In amplitude compensation processing, the compensation unit 64, similarly to the phase compensation processing, defines a linear equation for each of at least Ns+Nr−1 belonging sets of virtual antennas V, based on the amplitude difference of the peaks in the beat signal, with the amplitude errors between transmission circuits 3 and between reception circuits 4 as unknowns. The compensation unit 64 acquires the solution to this linear equation as the relative amplitude error. The amplitude difference of the peaks in the beat signal is an example of a comparison result of the reception signals between virtual antennas V.

The amplitude error due to wiring length difference relative to the reference wiring length Lo increases linearly according to the wiring length difference, similarly to the phase error. The amount of increase in amplitude error according to the wiring length difference varies with temperature. That is, the amplitude error due to wiring length difference is a value obtained by multiplying the wiring length difference by a parameter α.

In the following description, the same sets of virtual antennas V used in the above phase compensation processing are also used in amplitude compensation processing. In the following description, the amplitude at the peak of the beat signal corresponding to virtual antenna Vn is denoted as A_{Vn} (where n is a natural number). Let the amplitude error due to wiring length difference L_{abij} be G_{abij}. The amplitude difference of the peaks A_{V3}-A_{V7} for (V3, V7) can be defined by the relationship shown in Equation (8); the amplitude difference of the peaks A_{V9}-A_{V13} for (V9, V13) can be defined by the relationship shown in Equation (9); and the amplitude difference of the peaks A_{V11}-A_{V15} for (V11, V15) can be defined by the relationship shown in Equation (10).

$$( Equation 8 )$$

$${A}_{V 3} - {A}_{V 7} = ( {G}_{a} + {G}_{tx 1} + {G}_{r x 2} + {G}_{1121} ) - ( {G}_{a} + {G}_{tx 1} + {G}_{r x 1} + {G}_{1211} ) \qquad ( 8 )$$

$$( Equation 9 )$$

$${A}_{V 9} - {A}_{V 13} = ( {G}_{b} + {G}_{tx 1} + {G}_{r x 2} + {G}_{1221} ) - ( {G}_{b} + {G}_{tx 2} + {G}_{r x 1} + {G}_{2111} ) \qquad ( 9 )$$

$$( Equation 10 )$$

$${A}_{V 11} - {A}_{V 15} = ( {G}_{c} + {G}_{tx 1} + {G}_{r x 1} + {G}_{1213} ) - ( {G}_{c} + {G}_{tx 2} + {G}_{r x 2} + {G}_{2121} ) \qquad ( 10 )$$

If the amplitude error G_{abij} is replaced with L_{abij} a, the above equations (8) to (10) can be transformed into the following equations (11) to (13):

$$( Equation 11 )$$

$${A}_{V 3} - {A}_{V 7} = {G}_{r x 2} + ( {L}_{1121} - {L}_{1211} ) \cdot α \qquad ( 11 )$$

$$( Equation 12 )$$

$${A}_{V 9} - {A}_{V 13} = - {G}_{tx 2} + {G}_{r x 2} + ( {L}_{1221} - {L}_{2111} ) \cdot α \qquad ( 12 )$$

$$( Equation 13 )$$

$${A}_{V 11} - {A}_{V 15} = - {G}_{tx 2} - {G}_{r x 2} + ( {L}_{1213} - {L}_{2121} ) \cdot α \qquad ( 13 )$$

When equations (11) to (13) are converted into matrix form, the amplitude differences of each set and the relative amplitude errors satisfy the relationship expressed by the following Equation (14):

$$( Equation 14 )$$

$$( \begin{matrix}{A}_{V 3} - {A}_{V 7} \\ {A}_{V 9} - {A}_{V 13} \\ {A}_{V 11} - {A}_{V 15}\end{matrix} ) = ( \begin{matrix}0 & 1 & {L}_{1121} - {L}_{1211} \\ - 1 & 1 & {L}_{1222} - {L}_{2112} \\ - 1 & - 1 & {L}_{1213} - {L}_{2121}\end{matrix} ) \cdot ( \begin{matrix}{G}_{tx 2} \\ {G}_{r x 2} \\ α\end{matrix} ) \qquad ( 14 )$$

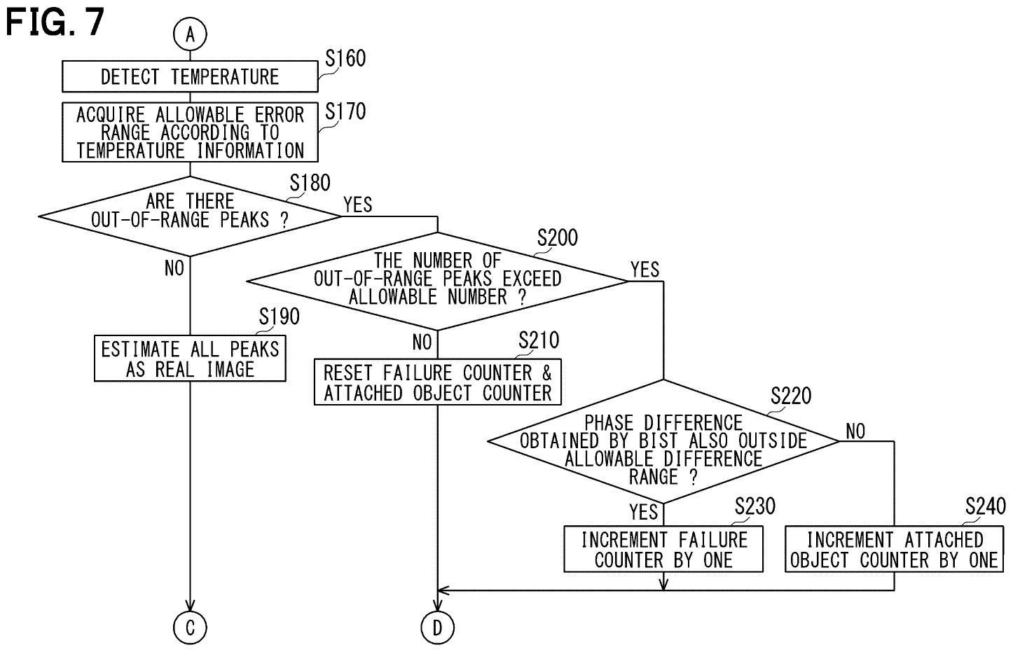

Here, the term on the left side of Equation (14) is the amplitude difference vector Y4 between overlapping virtual antennas V. The first term on the right side of Equation (14) is the coefficient matrix A4. The second term is the amplitude error vector X2. The amplitude difference vector Y4 can be calculated from the peak amplitude of each beat signal. The coefficient matrix A4 is a constant matrix defined by the combination of transmission circuit 3, reception circuit 4, and wiring length for each set of virtual antennas V. Thus, the compensation unit 64 acquires Gₜₓ₂, Gᵣₓ₂, and a as the solution to Equation (14), as the relative amplitude error of the second transmission circuit 3_2 with respect to the first transmission circuit 3_1, the relative amplitude error of the second reception circuit 4_2 with respect to the first reception circuit 4_1, and the relative amplitude error due to wiring length. After the processing in S90, the flow proceeds to S160 in FIG. 7.

On the other hand, if it is determined in S70 that no valid peak exists, the flow proceeds to S100. In S100, the compensation unit 64 acquires the temperature of each transmission circuit 3 and each reception circuit 4 from the temperature sensor 5. Then, in S110, the compensation unit 64 reads, from the memory 6a, a correction table for phase error and amplitude error between transmission circuits 3 according to temperature.

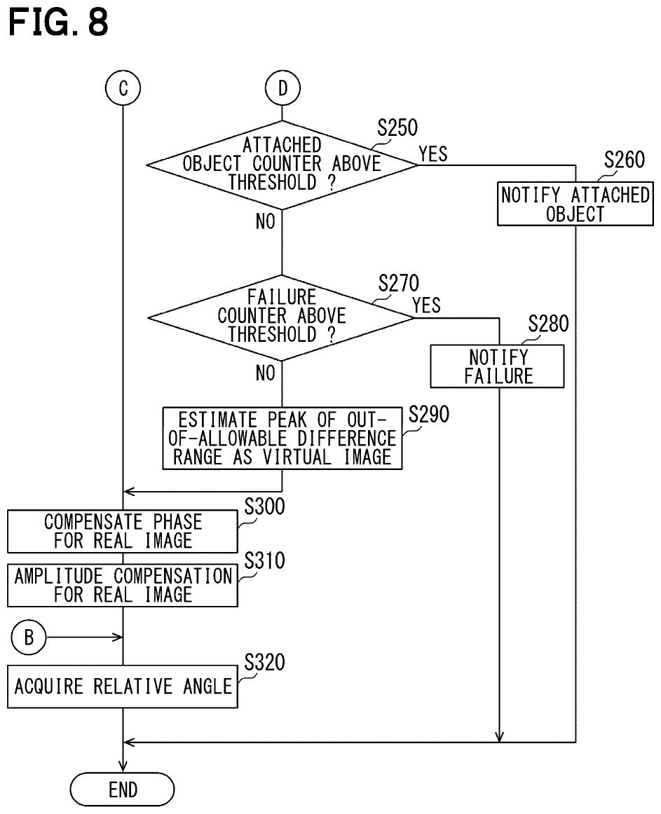

Next, in S120, the compensation unit 64 acquires the relative phase error between transmission circuits 3 and between reception circuits 4 by comparing the acquired temperature with the correction table. In S130, the compensation unit 64 acquires the relative amplitude error between transmission circuits 3 and between reception circuits 4 by comparing the acquired temperature with the correction table. After the processing in S130, in S140, the compensation unit 64 compensates for the relative phase error between transmission circuits 3 and between reception circuits 4. Furthermore, in S150, the compensation unit 64 compensates for the relative amplitude error between transmission circuits 3 and between reception circuits 4. Thereafter, the flow proceeds to S320 in FIG. 8.

Proceeding to FIG. 7, in S160, the temperature detection unit 65 acquires temperature information from the temperature sensor 5. The temperature detection unit 65 is an example of a “temperature acquisition unit.” In the subsequent S170, the diagnosis unit 66 acquires the allowable error range, which is the allowable range of phase error according to the temperature information. For example, the diagnosis unit 66 acquires the allowable error range for the transmission phase error among the transmission phase error and reception phase error. The allowable error range is the range of transmission phase error that is permitted when a non-multipath reflected wave is received by a radar device 1 without defects. The allowable error range is, for example, a range of transmission phase error that is equal to or greater than a lower threshold value and less than or equal to an upper threshold value.

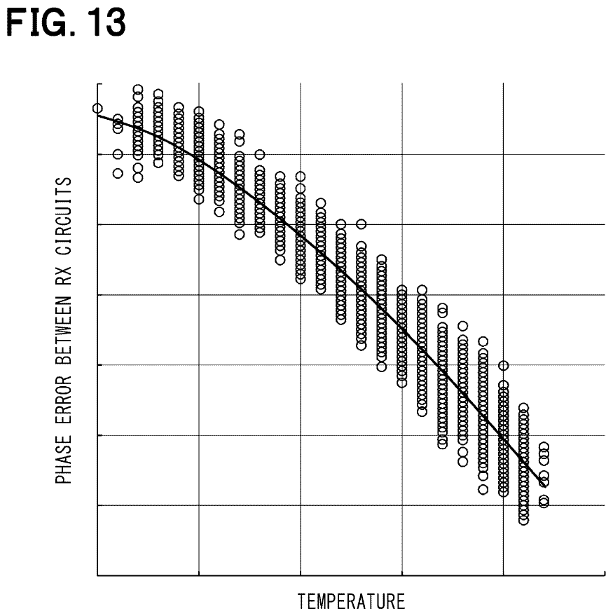

As shown in FIG. 12, a correlation exists between the temperature information and the relative phase error between transmission circuits 3. Similarly, as shown in FIG. 13, a correlation exists between the temperature information and the relative phase error between reception circuits 4. Therefore, the diagnosis unit 66 can define the range of phase error that may occur between transmission circuits 3 and reception circuits 4 according to the temperature information as the allowable error range. For example, the diagnosis unit 66 defines the allowable error range based on these correlations stored in a storage medium such as the memory 6a, in the form of relational expressions or tables. As the relational expression for the correlation, for example, a regression equation estimated from the correlation data shown in FIG. 12 and FIG. 13 may be stored.

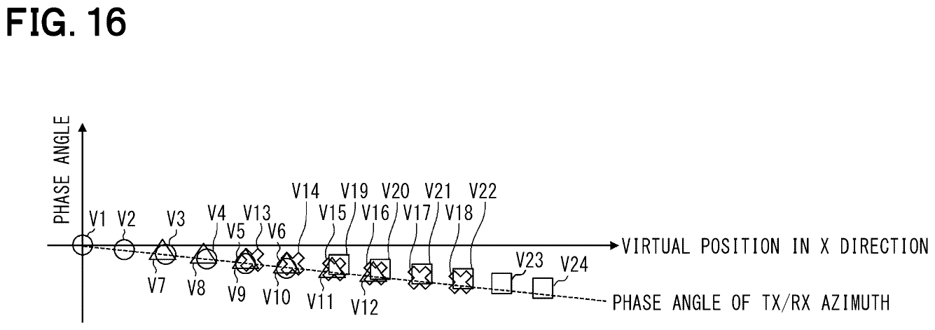

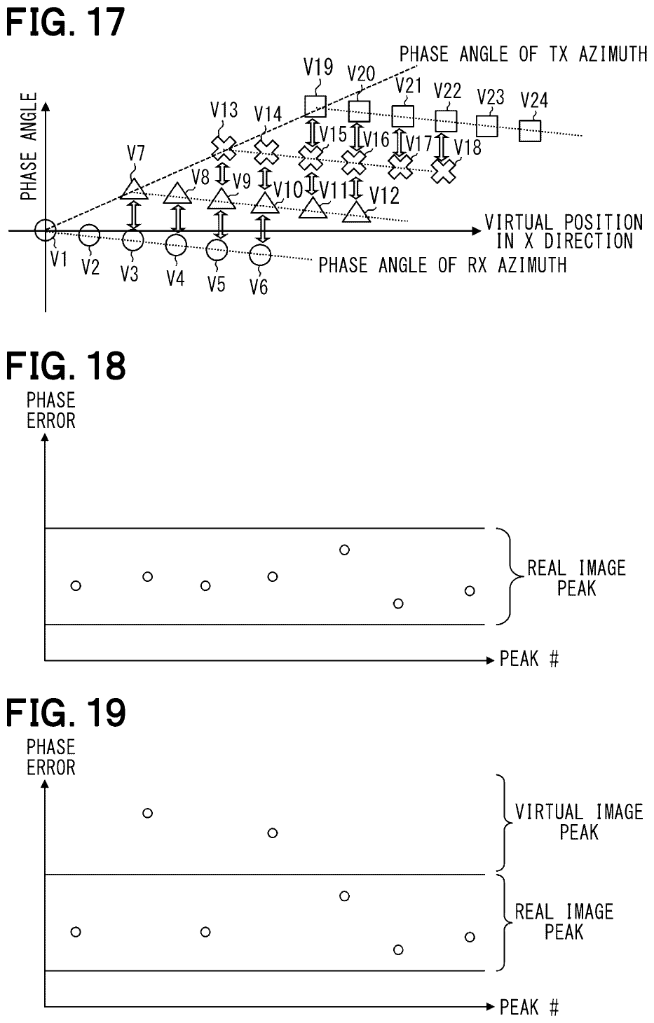

The allowable error range is defined as the range of phase errors assumed for real image peaks, that is, peaks with coincident paths under normal transmission and reception conditions. In this case, as shown in FIG. 16, the phase difference of the same peak between virtual antennas V with overlapping virtual positions becomes relatively small. In the case of multipath, since the path length increases, the phase changes, and as shown in FIG. 17, the phase difference of the peaks in the set of virtual antennas V becomes large, resulting in the phase error falling outside the allowable error range.

Then, in S180, the diagnosis unit 66 determines whether there is an out-of-range peak, which is a peak whose calculated transmission phase error falls outside the allowable error range among the plurality of peaks. If there is no out-of-range peak, the reflector detected as the corresponding peak can be estimated as a real image Ir. On the other hand, if there is an out-of-range peak, the reflector detected as the corresponding peak can be estimated as a virtual image Iv due to multipath. Since each peak corresponds to a reflector from which the signal is reflected, the number of peaks corresponds to the number of reflectors. That is, an out-of-range peak is an example of an “out-of-range reflector.”

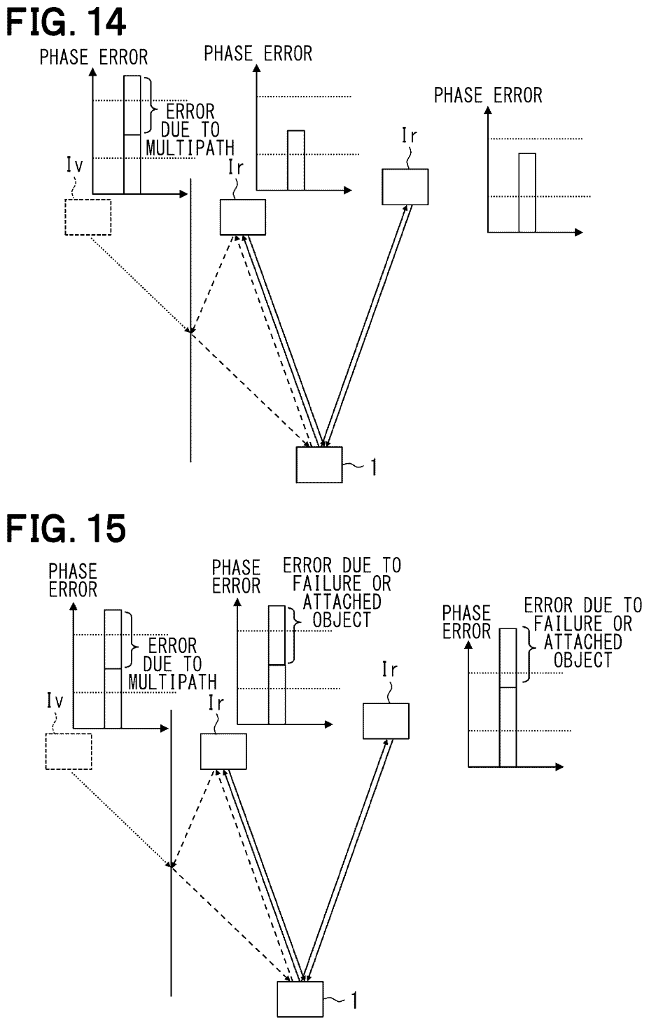

That is, as shown in FIG. 14, in the case of a reflector of a real image Ir, the path of the transmission signal from the transmission antenna TX to the target and the path of the reflected signal from the reflector to the reception antenna RX substantially coincide. Therefore, the phase error calculated based on this peak falls within the allowable error range. On the other hand, when multipath occurs, the path of the transmission signal from the transmission antenna TX to the target and the path of the reflected signal from the reflector to the reception antenna RX do not coincide. In this case, the peak of the virtual image Iv due to multipath will have a phase that changes according to the difference between the signal paths before and after reflection.

If it is determined in S180 that there is no out-of-range peak, that is, as shown in FIG. 18, all peaks fall within the allowable error range, the flow proceeds to S190. The allowable error range is indicated by the solid line in the graph in FIG. 18. In S190, the diagnosis unit 66 estimates that all peaks correspond to real images Ir. On the other hand, if it is determined in S180 that there is an out-of-range peak, the flow proceeds to S200.

In S200, the diagnosis unit 66 determines whether the number of out-of-range peaks exceeds the allowable upper limit number. Here, the allowable upper limit number is the number of virtual image peaks permitted under normal transmission and reception conditions. Under normal transmission and reception conditions, as shown in FIG. 19, only peaks substantially originating from multipath (virtual image peaks) become out-of-range peaks. However, under abnormal transmission and reception conditions, even real image peaks may become out-of-range peaks.

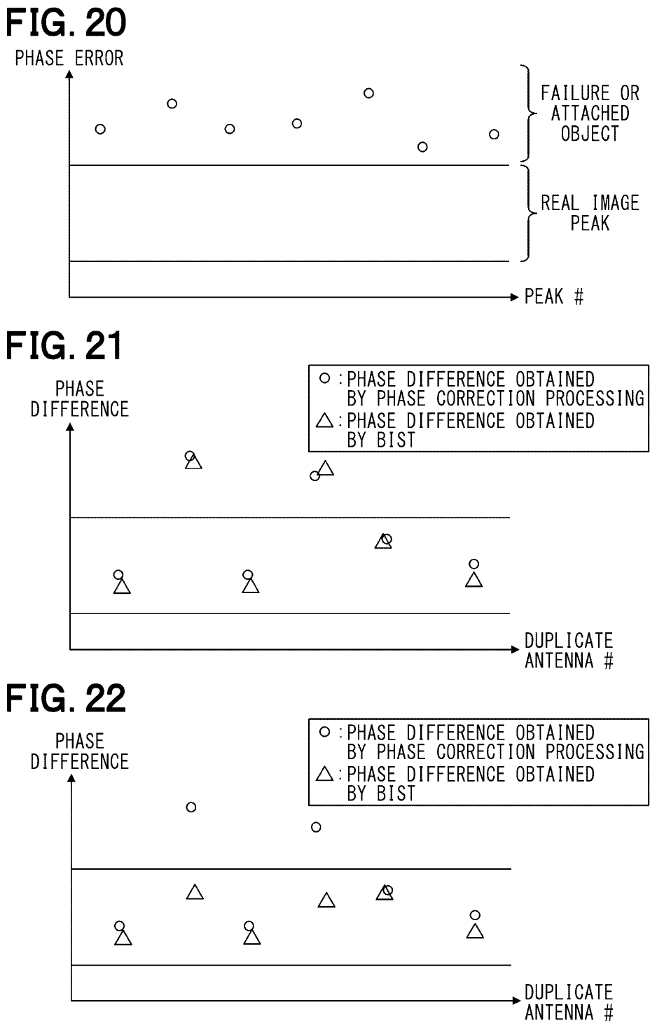

Here, an abnormal transmission and reception environment includes, for example, at least one of a failure of at least one of the transmission circuit 3 and the reception circuit 4, and signal obstruction due to a foreign matter (also referred to as an attached object, adhering substance) adhering to the radome 7a. In the case of failure, the phase of the signal processed by circuits 3, 4 may be shifted due to the influence of the failure. If foreign matter adheres, the reception signal strength decreases as the antennas TX, RX are covered by the foreign matter. As a result, the S/N ratio becomes insufficient, and the variation in the phase of the signal may increase. Due to these factors, under abnormal transmission and reception conditions, as shown in FIG. 15, even real image peaks may become out-of-range peaks. In this case, as shown in FIG. 20, the number of out-of-range peaks becomes greater than under normal transmission and reception conditions. Therefore, the diagnosis unit 66 can determine whether the transmission and reception environment is normal or abnormal by determining whether the number of out-of-range peaks exceeds the allowable upper limit number.

In S210, the diagnosis unit 66 resets the failure counter and a foreign matter counter that were counted up to the previous cycle. On the other hand, if it is determined that the number of out-of-range peaks exceeds the allowable upper limit number, the flow proceeds to S220.

In S220, the diagnosis unit 66 determines, for the phase difference between virtual antennas V with overlapping virtual positions, whether each of the phase differences acquired in the phase compensation processing and the phase differences acquired by methods other than the phase compensation processing fall outside the allowable difference range. The phase difference acquired in the phase compensation processing is the difference between the phases calculated from the received signals obtained at each virtual antenna V with overlapping virtual positions for the same peak. The allowable difference range is the range of phase differences permitted under normal transmission and reception conditions, i.e., a range equal to or greater than a lower threshold value and less than or equal to an upper threshold value for the phase difference. A method other than the compensation processing may be, for example, calculation of the phase difference by a built-in self-test (BIST) function. The phase difference acquired by a method other than the phase compensation processing is, for example, a phase difference acquired in accordance with an internal signal such as a test signal in the radar device 1, which does not involve transmission and reception of signals to and from the outside, and is acquired for each channel of circuits 3 and 4 corresponding to the virtual antennas V.

Here, if the abnormality in the transmission and reception environment is due to a failure of circuits 3 or 4, the phase difference obtained by a method other than compensation processing will also fall outside the allowable difference range. On the other hand, if the abnormality in the transmission and reception environment is due to foreign matter, the phase difference obtained by a method other than compensation processing will fall within the allowable difference range. Therefore, as shown in FIG. 21, if there is a set of virtual antennas V for which both the phase difference acquired in the compensation processing and the phase difference obtained by a method other than compensation processing fall outside the allowable difference range, it can be estimated that the abnormality in the transmission and reception environment is due to a failure of circuits 3 or 4. The allowable difference range in FIG. 21 is indicated by the solid line in the graph. On the other hand, as shown in FIG. 22, if there is no set of virtual antennas V for which both the phase difference acquired in the compensation processing and the phase difference acquired by a method other than compensation processing fall outside the allowable difference range, it can be estimated that the abnormality in the transmission and reception environment is due to foreign matter. Note that, even if there is a set of virtual antennas V for which both the phase difference acquired in the compensation processing and the phase difference acquired by a method other than compensation processing fall outside the allowable difference range, if the number of such sets is within the upper limit number of sets, the diagnosis unit 66 may estimate that the abnormality in the transmission and reception environment is due to foreign matter. In other words, the upper limit number of sets may be zero or may be one.

If it is determined in S220 that the phase difference by BIST is outside the allowable difference range, the flow proceeds to S230, where the diagnosis unit 66 increments the failure counter, which is a counter for failure diagnosis. On the other hand, if it is determined that the phase error by BIST is within the allowable difference range, the flow proceeds to S240. In S240, the diagnosis unit 66 increments the foreign matter counter, which is a counter for diagnosing the adhesion of foreign matter to the radome 7a.

Proceeding to FIG. 8, in S250, the diagnosis unit 66 determines whether the foreign matter counter has reached or exceeded the threshold value. If it is determined that the foreign matter counter has reached or exceeded the threshold value, the flow proceeds to S260. In S260, the diagnosis unit 66 outputs a foreign matter notification. For example, the diagnosis unit 66 may output the foreign matter notification to another ECU installed in the vehicle. Alternatively, the diagnosis unit 66 may output the foreign matter notification to an external center outside the vehicle.

On the other hand, if it is determined that the foreign matter counter is below the threshold value, the flow proceeds to S270. In S270, the diagnosis unit 66 determines whether the failure counter has reached or exceeded the threshold value. If it is determined that the failure counter has reached or exceeded the threshold value, the flow proceeds to S280. In S280, the diagnosis unit 66 outputs a failure notification. For example, the diagnosis unit 66 may output the failure notification to another ECU installed in the vehicle. Alternatively, the diagnosis unit 66 may output the failure notification to an external center outside the vehicle.

On the other hand, if it is determined that the failure counter is below the threshold value, the flow proceeds to S290. In S290, the diagnosis unit 66 estimates that the out-of-range peak is due to a virtual image Iv, that is, due to multipath.

In S300, the compensation unit 64 performs phase compensation for the peaks estimated to be real images Ir. For example, the compensation unit 64 stores the acquired relative phase error in the memory 6a as compensation data for use in subsequent relative angle acquisition. Furthermore, in S310, the compensation unit 64 compensates for the relative amplitude error between transmission circuits 3 and between reception circuits 4 by storing the compensation data in the memory 6a.

Proceeding to FIG. 8, in S320, the angle acquisition unit 67 acquires the relative angle of the reflector based on the phase information of the peaks estimated to be real images Ir and compensated. Specifically, the angle acquisition unit 67 executes FFT processing for the plurality of peaks extracted from the beat signals based on the received signals of each compensated virtual antenna V, thereby acquiring the phase difference between virtual antennas V. Since the phase difference between virtual antennas V is related to the relative angle of the target, the angle acquisition unit 67 converts the acquired phase difference into a relative angle to obtain the relative angle. At this time, the angle acquisition unit 67 utilizes the compensation data to acquire the relative angle while compensating for the phase difference between transmission circuits 3 and between reception circuits 4.

According to this first embodiment, when the number of out-of-range peaks, which are reflectors for which errors outside the allowable error range permitted according to the temperature information are acquired, falls within the allowable upper limit number, it is diagnosed that the out-of-range peaks are virtual images Iv, and when the number of out-of-range peaks exceeds the allowable upper limit number, it is diagnosed that at least one of the transmission circuit or reception circuit is faulty. Therefore, the radar device 1 can distinguish between multipath and failure.

### Second Embodiment

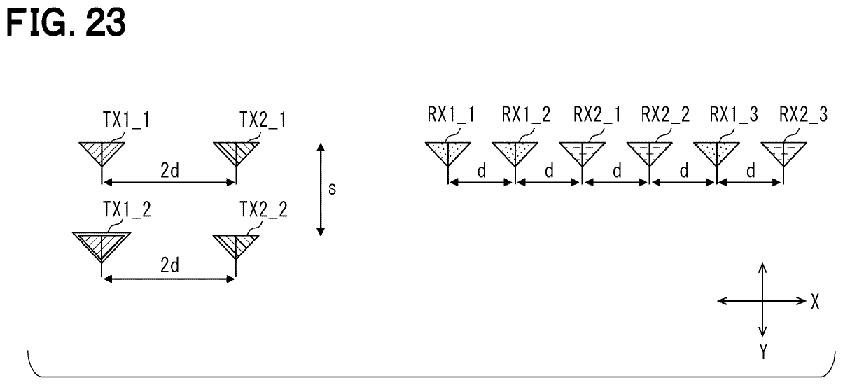

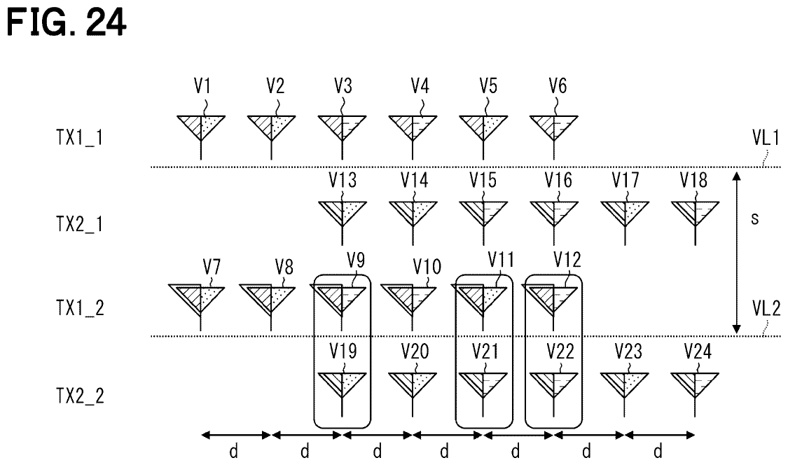

As shown in FIG. 23 and FIG. 24, the second embodiment is a modification of the first embodiment. In the second embodiment, the transmission antennas TX are arranged in a two-dimensional configuration. That is, the transmission antennas TX are arranged at equal intervals in each of two reference directions.

In the second embodiment, the number of transmission antennas TX and reception antennas RX is the same as in the first embodiment. Similarly, the number of transmission circuits 3 and reception circuits 4 is also the same as in the first embodiment.

In the example shown in FIG. 23, transmission antennas TX1_1 and TX2_1 are arranged at intervals of 2d in the X direction from one side to the other in this order. Furthermore, transmission antennas TX1_1 and TX1_2 are arranged at intervals of s in the Y direction, which is orthogonal to the X direction, from one side to the other in this order. Also, transmission antennas TX2_1 and TX2_2 are arranged at intervals of s in the Y direction from one side to the other in this order. That is, transmission antennas TX1_2 and TX2_2 are arranged in parallel to transmission antennas TX1_1 and TX2_1, with an interval of 2d.

In addition, reception antennas RX1_1, RX1_2, RX2_1, RX2_2, RX2_3, and RX1_3 are arranged at intervals of d in the X direction from one side to the other in this order. Since the number of antennas TX and RX is the same as in the first embodiment, a total of 24 virtual antennas V are also assumed in the second embodiment, as shown in FIG. 24.

Since adjacent transmission antennas TX in the X direction are arranged at intervals of 2d, the row of virtual antennas V assumed for a particular transmission antenna TX will have virtual positions that are relatively shifted by 2d from the row of virtual antennas V assumed for an adjacent transmission antenna TX in the X direction. Furthermore, since adjacent transmission antennas TX in the Y direction are arranged at intervals of s, the row of virtual antennas V assumed for a particular transmission antenna TX will have virtual positions that are relatively shifted by s from the row of virtual antennas V assumed for an adjacent transmission antenna TX in the Y direction.

Note that, in FIG. 24, as in FIG. 4, the virtual positions of the plurality of virtual antennas V for each transmission antenna TX are depicted shifted in the vertical direction of the page for clarity. In practice, the plurality of virtual antennas V assumed for transmission antennas TX1_1 and TX2_1 are assumed to have their respective virtual positions on a virtual line VL1 extending in the X direction. Similarly, the plurality of virtual antennas V assumed for transmission antennas TX1_2 and TX2_2 are assumed to have their respective virtual positions on a virtual line VL2 extending in the X direction. The row of virtual antennas V on virtual line VL1 and the row of virtual antennas V on virtual line VL2 are separated by a distance of s in the Y direction.

Therefore, as shown in FIG. 24, sets of virtual antennas V with overlapping virtual positions can be assumed between the plurality of virtual antennas V assumed for transmission antenna TX1_1 and the plurality of virtual antennas V assumed for transmission antenna TX2_1. Specifically, (V3, V13), (V4, V14), (V5, V15), and (V6, V16) constitute sets of virtual antennas V with overlapping virtual positions.

Similarly, sets of virtual antennas V with overlapping virtual positions can be assumed between the plurality of virtual antennas V assumed for transmission antenna TX1_2 and the plurality of virtual antennas V assumed for transmission antenna TX2_2. Specifically, (V9, V19), (V10, V20), (V11, V21), and (V12, V22) constitute sets of virtual antennas V with overlapping virtual positions.

All of the above sets constitute a collection of sets in which the combination of transmission circuit 3 and reception circuit 4 does not overlap between the virtual antennas V in each set. Among this collection, the number of sets in which the combination of transmission circuit 3 and reception circuit 4 does not overlap with other sets is three, thereby satisfying the condition of at least Ns+Nr−2 sets.

One example of these three sets is (V3, V13), (V5, V15), and (V6, V16). Furthermore, another example of three sets is (V9, V19), (V11, V21), and (V12, V22).

Note that (V4, V14), (V9, V19), and (V10, V20) have the same combination of transmission circuit 3 and reception circuit 4 as (V3, V13), but do not overlap with other sets. Therefore, assuming (V4, V14), (V9, V19), or (V10, V20) as one of the three sets is equivalent to assuming (V3, V13). Similarly, assuming (V11, V21) as one of the three sets is equivalent to assuming (V5, V15), and assuming (V12, V22) is equivalent to assuming (V6, V16).

Furthermore, among the above unique sets, the three sets (V9, V19), (V11, V21), and (V12, V22) are also sets with different wiring lengths. Therefore, the condition of at least one set of different wiring length sets is also satisfied.

As a result, there are at least three belonging sets belonging to at least one of the unique sets or different wiring length sets, thereby satisfying the condition of at least Ns+Nr−1 sets. For example, (V9, V19), (V11, V21), and (V12, V22) can be assumed as the three belonging sets. Note that one or two of (V9, V19), (V11, V21), and (V12, V22) as belonging sets may be replaced with the above-mentioned equivalent sets.

### Third Embodiment

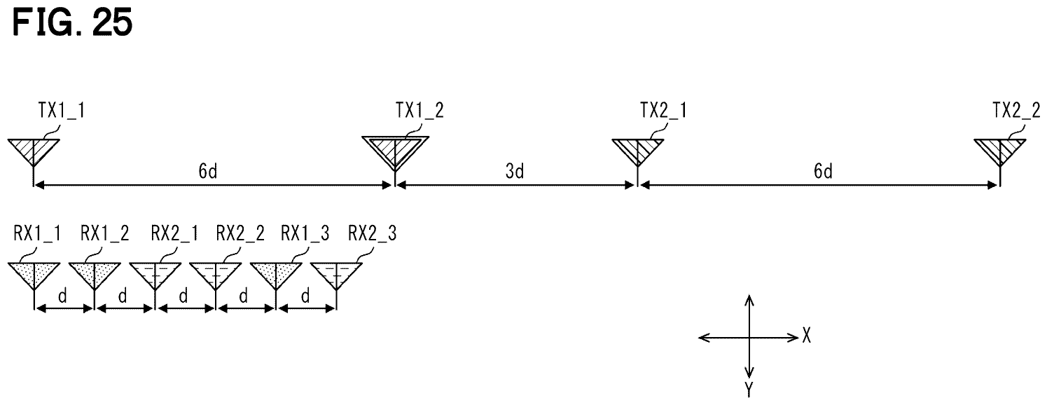

As shown in FIG. 25 to FIG. 27, the third embodiment is a modification of the first embodiment. In the radar device 1 of the third embodiment, the number of transmission antennas TX and reception antennas RX, as well as the number of transmission circuits 3 and reception circuits 4, are the same as in the first embodiment. Furthermore, the combinations of transmission antennas TX and transmission circuits 3, and reception antennas RX and reception circuits 4, are assumed to be the same as those shown in FIG. 2.

In this embodiment, the transmission antennas TX are arranged at uneven spacing. In the example shown in FIG. 25, transmission antennas TX1_1, TX1_2, TX2_1, and TX2_2 are arranged in this order from one side to the other in the X direction as the reference direction. Transmission antenna TX1_1 and transmission antenna TX1_2 are arranged with a spacing of 6d. Transmission antenna TX1_2 and transmission antenna TX2_1 are arranged with a spacing of 3d. Transmission antenna TX2_1 and transmission antenna TX2_2 are arranged with a spacing of 6d.

Furthermore, reception antennas RX1_1, RX1_2, RX2_1, RX2_2, RX2_3, and RX1_3 are arranged at intervals of d in the reference direction from one side to the other in this order.

For each transmission antenna TX1_1, TX1_2, TX2_1, and TX2_2, six virtual antennas V are assumed, corresponding to the number of reception antennas RX. Therefore, in this embodiment, a total of 24 virtual antennas V are assumed.

Here, the plurality of virtual antennas V assumed for transmission antenna TX1_1, from one side to the other, are denoted as virtual antennas V1, V2, V3, V4, V5, and V6. The plurality of virtual antennas V assumed for transmission antenna TX1_2, from one side to the other, are denoted as virtual antennas V7, V8, V9, V10, V11, and V12. The group of virtual antennas V assumed for transmission antenna TX2_1, from one side to the other, are denoted as virtual antennas V13, V14, V15, V16, V17, and V18. The group of virtual antennas V assumed for transmission antenna TX2_2, from one side to the other, are denoted as virtual antennas V19, V20, V21, V22, V23, and V24.

Since transmission antennas TX1_1 and TX1_2 are arranged at an interval of 6d, the group of virtual antennas V assumed for transmission antenna TX1_1 will have virtual positions that are relatively shifted by 6d from the group of virtual antennas V assumed for transmission antenna TX1_2. Similarly, since transmission antennas TX1_2 and TX2_1 are arranged at an interval of 3d, the group of virtual antennas V assumed for transmission antenna TX1_2 will have virtual positions that are relatively shifted by 3d from the group of virtual antennas V assumed for transmission antenna TX2_1. Furthermore, since transmission antennas TX2_1 and TX2_2 are arranged at an interval of 6d, the group of virtual antennas V assumed for transmission antenna TX2_1 will have virtual positions that are relatively shifted by 6d from the group of virtual antennas V assumed for transmission antenna TX2_2.

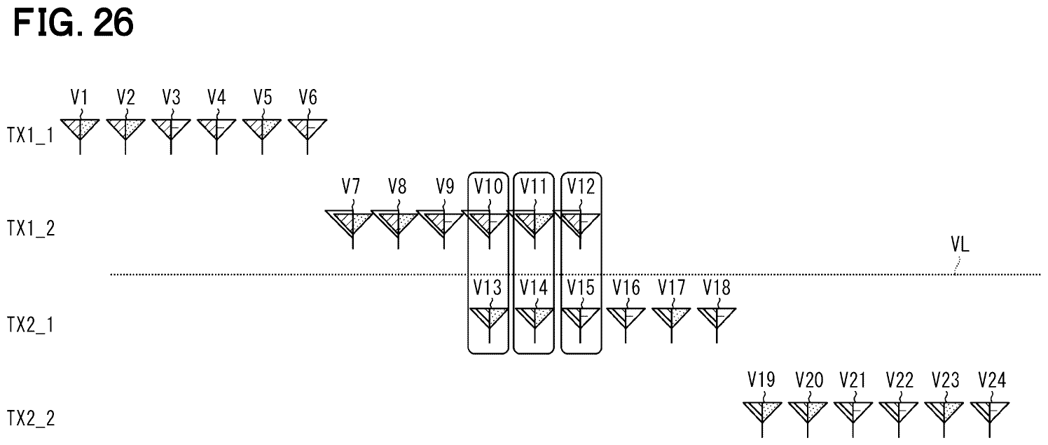

Therefore, with such an arrangement of antennas TX and RX, as shown in FIG. 26, there are three sets of virtual antennas V with overlapping virtual positions. In FIG. 26, as well, the virtual positions of the plurality of virtual antennas V for each transmission antenna TX are depicted shifted in the vertical direction of the page for clarity. In practice, the plurality of virtual antennas V are assumed to have their respective virtual positions on a virtual line VL extending in the reference direction (X direction). Specifically, (V10, V13), (V11, V14), and (V12, V15) constitute sets of virtual antennas V with overlapping virtual positions.

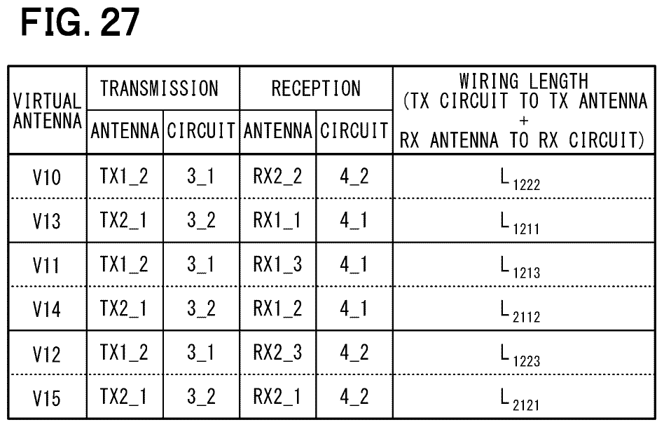

As shown in FIG. 26 and FIG. 27, these three sets constitute a collection of sets in which the combination of transmission circuit 3 and reception circuit 4 does not coincide between the virtual antennas V in each set. Furthermore, these three sets are sets in which the combination of transmission circuit 3 and reception circuit 4 does not overlap with each other. Therefore, in this antenna arrangement, the number of unique sets is three, satisfying the condition of at least Ns+Nr−2 sets.

Furthermore, these three sets are each different wiring length sets. That is, the wiring lengths of virtual antennas V10, V11, and V12 are longer than those of virtual antennas V13, V14, and V15. Therefore, in this antenna arrangement, the number of different wiring length sets is three, satisfying the condition of at least one set. Moreover, as a result, the number of belonging sets in this antenna arrangement is three, satisfying the condition of at least Ns+Nr−1 sets.

### Fourth Embodiment

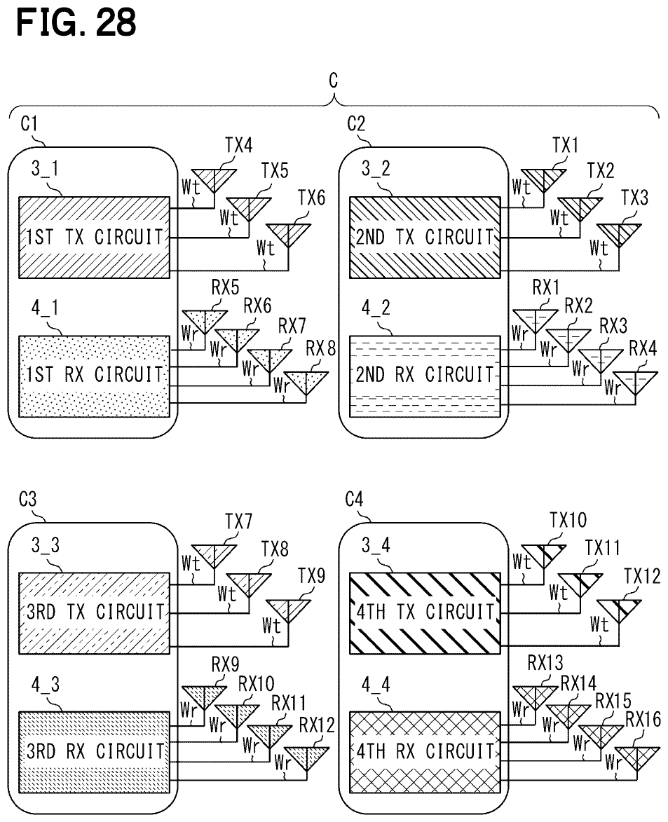

As shown in FIG. 28 to FIG. 31, the fourth embodiment is a modification of the first embodiment. In this embodiment, the transmission antennas TX and reception antennas RX are arranged in a two-dimensional configuration, and the transmission antennas TX are arranged at uneven spacing.

As an example of this embodiment, a radar device 1 is assumed in which twelve transmission antennas TX and sixteen reception antennas RX are implemented. Here, the number of transmission circuits 3 is Ns=4, and the number of reception circuits 4 is Nr=4. In this case, as shown in FIG. 28, the number of channels in one transmission circuit 3 is at least three, and the number of channels in one reception circuit 4 is at least four. In the following, the four transmission circuits 3 may be distinguished as the first transmission circuit 3_1, the second transmission circuit 3_2, the third transmission circuit 3_3, and the fourth transmission circuit 3_4. Similarly, the four reception circuits 4 may be distinguished as the first reception circuit 4_1, the second reception circuit 4_2, the third reception circuit 4_3, and the fourth reception circuit 4_4.

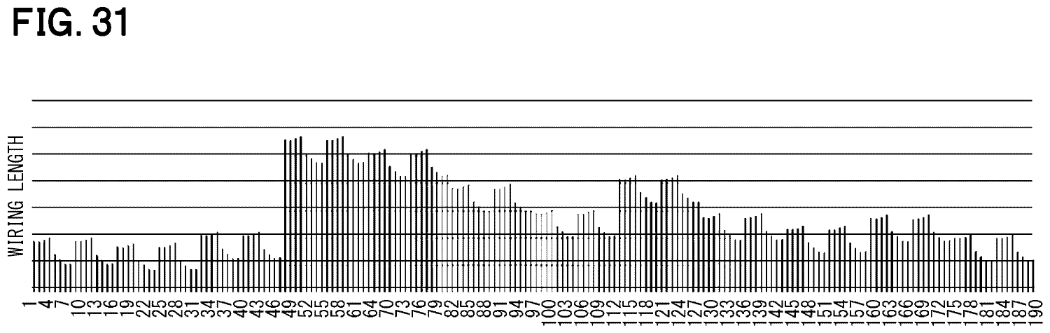

In this embodiment as well, each circuit is implemented on a plurality of circuit chips C. Specifically, the first transmission circuit 3_1 and the first reception circuit 4_1 are implemented on the same first circuit chip C1. The second transmission circuit 3_2 and the second reception circuit 4_2 are implemented on the same second circuit chip C2. In addition, the third transmission circuit 3_3 and the third reception circuit 4_3 are implemented on the same third circuit chip C3. The fourth transmission circuit 3_4 and the fourth reception circuit 4_4 are implemented on the same fourth circuit chip C4. The wiring length of each wiring Wt between the transmission antennas TX and the corresponding transmission circuits 3, and the wiring length of each wiring Wr between the reception antennas RX and the corresponding reception circuits 4, are defined such that the wiring length of each assumed virtual antenna V has the relative relationship shown in the graph of FIG. 31. That is, at least one of the wiring length from each transmission circuit 3 to each transmission antenna TX and the wiring length from each reception antenna RX to each reception circuit 4 is defined so that the wiring length of the corresponding virtual antenna V has the relative relationship shown in FIG. 31.

As in the first embodiment, the twelve transmission antennas TX and sixteen reception antennas RX may be distinguished by different reference numerals. Specifically, the three transmission antennas TX connected to the first transmission circuit 3_1 are denoted as transmission antennas TX4, TX5, and TX6; the three transmission antennas TX connected to the second transmission circuit 3_2 are denoted as transmission antennas TX1, TX2, and TX3. The three transmission antennas TX connected to the third transmission circuit 3_3 are denoted as transmission antennas TX7, TX8, and TX9; and the three transmission antennas TX connected to the fourth transmission circuit 3_4 are denoted as transmission antennas TX10, TX11, and TX12.

Similarly, the four reception antennas RX connected to the first reception circuit 4_1 are denoted as reception antennas RX5, RX6, RX7, and RX8; the four reception antennas RX connected to the second reception circuit 4_2 are denoted as reception antennas RX1, RX2, RX3, and RX4. The four reception antennas RX connected to the third reception circuit 4_3 are denoted as reception antennas RX9, RX10, RX11, and RX12; and the four reception antennas RX connected to the fourth reception circuit 4_4 are denoted as reception antennas RX13, RX14, RX15, and RX16.

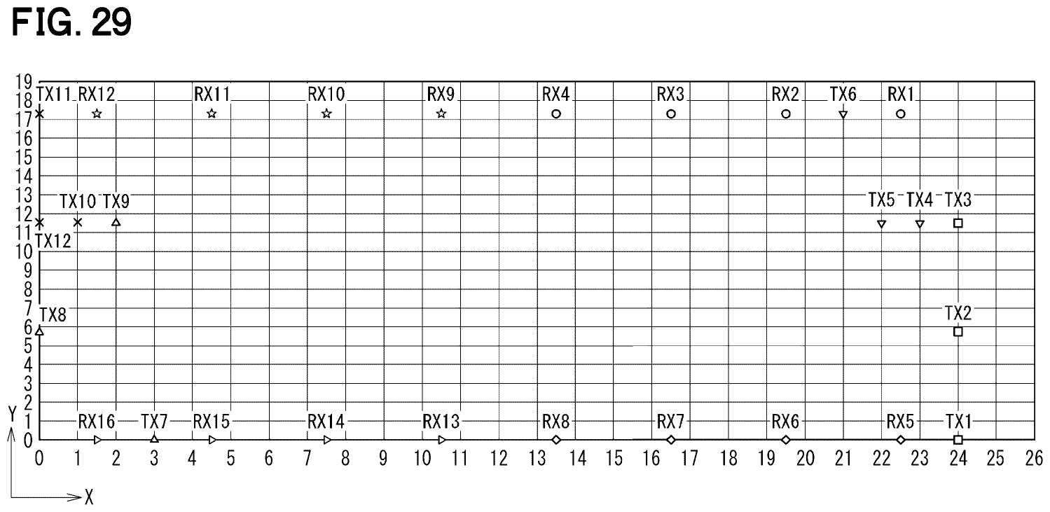

The above transmission antennas TX and reception antennas RX are arranged in a two-dimensional configuration. As shown in FIG. 29, four rows of multiple transmission antennas TX aligned in the X direction are spaced apart in the Y direction. Among these four rows aligned in the X direction, the first, second, and fourth rows from the origin side each have two transmission antennas TX arranged. Furthermore, in the third row from the origin side among the four rows aligned in the X direction, six transmission antennas TX are arranged. Here, let the interval of one scale in the X direction be d, and the interval of one scale in the Y direction be s. Transmission antennas TX12, TX10, and TX9 are arranged at equal intervals of d. Similarly, transmission antennas TX5, TX4, and TX3 are also arranged at equal intervals of d. On the other hand, the interval between transmission antenna TX9 and transmission antenna TX5 is 20d. That is, in this third row, the transmission antennas TX are arranged at uneven intervals in the X direction.

Furthermore, two rows of multiple reception antennas RX aligned in the X direction are spaced apart in the Y direction. In each of these two rows aligned in the X direction, eight reception antennas RX are arranged. In each row, these reception antennas RX are arranged at equal intervals in the X direction. Furthermore, among the two rows aligned in the X direction, the first row from the origin side is arranged so as to be aligned in the Y direction with the first row from the origin side of the transmission antennas TX. Similarly, the second row from the origin side among the two rows aligned in the X direction is arranged so as to be aligned in the Y direction with the fourth row from the origin side of the transmission antennas TX.

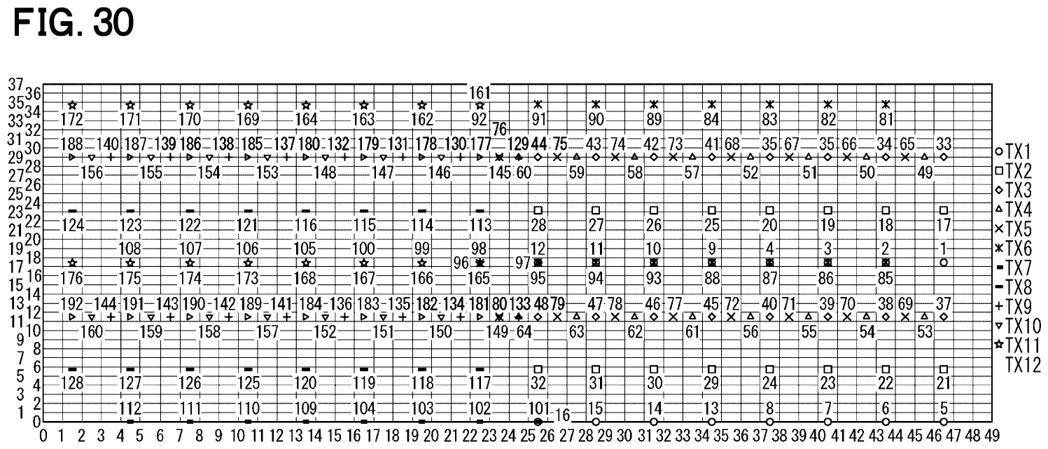

For each of the twelve transmission antennas TX, sixteen virtual antennas V are assumed, corresponding to the number of reception antennas RX. Therefore, in this embodiment, a total of 192 virtual antennas V are assumed. Specifically, the arrangement of the 192 virtual antennas V is as shown in FIG. 30.

In the following, among the sixteen virtual antennas V assumed for a specific transmission antenna TXa, the virtual antenna V corresponding to a specific reception antenna RXb (where a and b are natural numbers) is denoted as Vc (where c=(a−1)×16+b). Note that, in FIG. 30, the notation “V” is omitted to avoid complexity.

As shown in FIG. 30, there are 24 sets of virtual antennas V with overlapping virtual positions. Among these, there are 13 unique sets in which the combination of transmission circuit 3 and reception circuit 4 does not overlap with other sets. For example, (V2, V85), (V9, V88), (V10, V93), (V12, V97), (V16, V86), (V60, V129), (V64, V133), (V76, V145), (V80, V149), (V95, V97), (V98, V165), (V105, V168), and (V106, V173) can be assumed as unique sets. The compensation unit 64, described later, performs compensation processing based on the received signals that can be obtained at each virtual antenna V in at least six of these sets.

As in the first embodiment, the sets of virtual antennas V assumed for the compensation processing may be other than the above sets, as long as the combination of transmission circuit 3 and reception circuit 4 does not overlap with other sets. For example, (V3, V86) and (V4, V87) have the same combination of transmission circuit 3 and reception circuit 4 as (V2, V85), but do not overlap with other sets. Therefore, assuming (V3, V86) or (V4, V87) as one of the 13 sets is equivalent to assuming (V2, V85).

Here, since Ns=4 and Nr=4, the control unit 6, in the processing of S80 and S90, further calculates the phase error and amplitude error between transmission circuits 3, the phase error and amplitude error between reception circuits 4, and the phase error and amplitude error according to wiring length differences, from the beat signals of at least seven belonging sets.

When the number of antennas TX, RX is relatively large as described above, the arrangement of antennas TX, RX can be determined by a genetic algorithm. For example, as characteristics for evaluating the current generation generated by the genetic algorithm, overlap efficiency, rank, wiring efficiency, FOV, and separation angle can be mentioned. Overlap efficiency is a parameter obtained by dividing the full rank number by the number of channel reductions due to overlapping virtual positions, and it is desirable for this to be large. Rank is a predetermined parameter. Wiring efficiency is a parameter according to the variance of antenna coordinates input to the same circuit, and it is desirable for this to be small. FOV is a parameter according to the interval between antennas, and it is desirable for this to be small. Separation angle is a parameter according to the aperture length, and it is desirable for this to be large.

### Fifth Embodiment

The fifth embodiment is a modification of the first embodiment. As shown in the fifth embodiment, all wiring Wt and Wr for the transmission antennas TX and reception antennas RX may be of equal length.

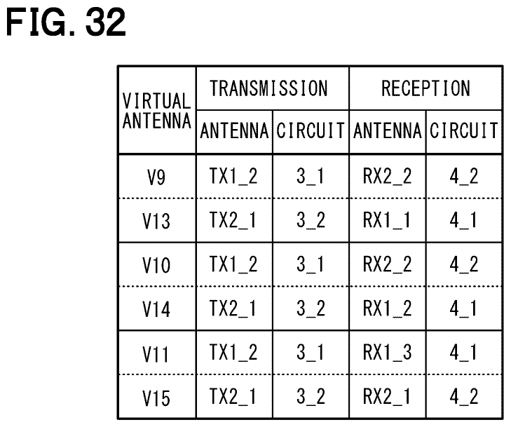

Details regarding the acquisition of relative phase error in the case of equal-length wiring are described below. In the following explanation, the phase at the peak of the beat signal corresponding to virtual antenna Vn is denoted as θ_{Vn} (where n is a natural number). For simplicity in the following description, only two sets in which the combination of transmission circuit 3 and reception circuit 4 does not overlap with other sets, namely (V9, V13) and (V11, V15) as shown in FIG. 32, are used. Additionally, as a combination that overlaps with the combination of transmission circuit 3 and reception circuit 4 for (V9, V13), one set (V10, V14) is used supplementally.

In this case, the phase difference at the peak for (V9, V13), θ_{V9}-θ_{V13}, can be defined by Equation (15); the phase difference at the peak for (V10, V14), θ_{V10}-θ_{V14}, can be defined by Equation (16); and the phase difference at the peak for (V11, V15), θ_{V11}-θ_{V15}, can be defined by Equation (17).

$$( Equation 15 )$$

$${θ}_{V 9} - {θ}_{V 13} = ( {Θ}_{a} + {e}_{tx 1} + {e}_{r x 2} ) - ( {Θ}_{a} + {e}_{tx 2} + {e}_{r x 1} ) \qquad ( 15 )$$

$$( Equation 16 )$$

$${θ}_{V 10} - {θ}_{V 14} = ( {Θ}_{b} + {e}_{tx 1} + {e}_{r x 2} ) - ( {Θ}_{b} + {e}_{tx 2} + {e}_{r x 1} ) \qquad ( 16 )$$

$$( Equation 17 )$$

$${θ}_{V 11} - {θ}_{V 15} = ( {Θ}_{c} + {e}_{tx 1} + {e}_{r x 1} ) - ( {Θ}_{c} + {e}_{tx 2} + {e}_{r x 2} ) \qquad ( 17 )$$

Θₐ, Θ_{b}, and Θ_{c} are phase errors caused by the target, respectively. eₜₓ₁ is the phase error of the signal generated in the first transmission circuit 3_1, and eₜₓ₂ is the phase error of the signal generated in the second transmission circuit 3_2. eᵣₓ₁ is the phase error of the signal generated in the first reception circuit 4_1, and eᵣₓ₂ is the phase error of the signal generated in the second reception circuit 4_2.

In phase compensation, it is sufficient to consider the relative phase error between transmission circuits 3 and the relative phase error between reception circuits 4. Therefore, if the relative phase error of the second transmission circuit 3_2 with respect to the first transmission circuit 3_1 and the relative phase error of the second reception circuit 4_2 with respect to the first reception circuit 4_1 are considered, eₜₓ₁ and eᵣₓ₁ can be set to zero. Accordingly, equations (15) to (17) can be transformed into the following equations (18) to (20).

$$( Equation 18 )$$

$${θ}_{V 9} - {θ}_{V 13} = - {e}_{tx 2} + {e}_{r x 2} \qquad ( 18 )$$

$$( Equation 19 )$$

$${θ}_{V 10} - {θ}_{V 14} = - {e}_{tx 2} + {e}_{r x 2} \qquad ( 19 )$$

$$( Equation 20 )$$

$${θ}_{V 11} - {θ}_{V 15} = - {e}_{tx 2} - {e}_{r x 2} \qquad ( 20 )$$

Here, when equations (18) to (20) are converted into matrix form, the phase differences of each set and the relative phase errors satisfy the relationship expressed by the following Equation (21).

$$( Equation 21 )$$

$$( \begin{matrix}{θ}_{V 9} - {θ}_{V 13} \\ {θ}_{V 10} - {θ}_{V 14} \\ {θ}_{V 11} - {θ}_{V 15}\end{matrix} ) = ( \begin{matrix}- 1 & 1 \\ - 1 & 1 \\ - 1 & - 1\end{matrix} ) \cdot ( \begin{matrix}{e}_{tx 2} \\ {e}_{rx 2}\end{matrix} ) \qquad ( 21 )$$

The left-hand side term of Equation (21) is the phase difference vector Y1 between overlapping virtual antennas V. The first term on the right-hand side of Equation (21) is the coefficient matrix A1, and the second term is the phase error vector X1. The phase difference vector Y1 in Equation (21) can be calculated from the phase at the peak of each beat signal. The coefficient matrix A1 is a constant matrix defined by the combination of transmission circuit 3 and reception circuit 4 for each set of virtual antennas V. Therefore, Equation (21) can be solved as a system of simultaneous equations with eₜₓ₂ and eᵣₓ₂ as unknowns. That is, the compensation unit obtains eₜₓ₂ and eᵣₓ₂, as the solution to Equation (21), as the relative phase error of the second transmission circuit 3_2 with respect to the first transmission circuit 3_1, and the relative phase error of the second reception circuit 4_2 with respect to the first reception circuit 4_1.

In amplitude compensation processing, the compensation unit 64, similarly to the phase compensation processing, defines a linear equation for each unique set based on the amplitude difference at the peak of the beat signal, with the amplitude errors between transmission circuits 3 and between reception circuits 4 as unknowns, and obtains the solution to this linear equation as the relative amplitude error. The amplitude difference at the peak of the beat signal is an example of the comparison result of the received signals between virtual antennas V.

In the following, it is assumed that the same sets of virtual antennas V as in the above phase compensation processing are also used in the amplitude compensation processing. In this case, the amplitude difference at the peak for (V9, V13), A_{V9}-A_{V13}, can be defined by Equation (22); the amplitude difference at the peak for (V10, V14), A_{V10}-A_{V14}, can be defined by Equation (23); and the amplitude difference at the peak for (V11, V15), A_{V11}-A_{V15}, can be defined by Equation (24).

$$( Equation 22 )$$

$${A}_{V 9} - {A}_{V 13} = ( {G}_{a} + {G}_{tx 1} + {G}_{r x 2} ) - ( {G}_{a} + {G}_{tx 2} + {G}_{r x 1} ) \qquad ( 22 )$$

$$( Equation 23 )$$

$${A}_{V 10} - {A}_{V 14} = ( {G}_{b} + {G}_{tx 1} + {G}_{r x 2} ) - ( {G}_{b} + {G}_{tx 2} + {G}_{r x 1} ) \qquad ( 23 )$$

$$( Equation 24 )$$

$${A}_{V 11} - {A}_{V 15} = ( {G}_{c} + {G}_{tx 1} + {G}_{r x 1} ) - ( {G}_{c} + {G}_{tx 2} + {G}_{r x 2} ) \qquad ( 24 )$$

In the above equations, Gₐ, G_{b}, and G_{c} are amplitude errors caused by the target, respectively. Gₜₓ₁ is the amplitude error of the signal generated in the first transmission circuit 3_1, and Gₜₓ₂ is the amplitude error of the signal generated in the second transmission circuit 3_2. Gᵣₓ₁ is the amplitude error of the signal generated in the first reception circuit 4_1, and Gᵣₓ₂ is the amplitude error of the signal generated in the second reception circuit 4_2.

Here, similarly to phase compensation, if the relative amplitude error of the second transmission circuit 3_2 with respect to the first transmission circuit 3_1 and the relative amplitude error of the second reception circuit 4_2 with respect to the first reception circuit 4_1 are considered, Gₜₓ₁ and Gᵣₓ₁ can be set to zero. Therefore, equations (22) to (24) can be transformed into the following equations (25) to (27).

$$( Equation 25 )$$

$${A}_{V 9} - {A}_{V 13} = - {G}_{tx 2} + {G}_{r x 2} \qquad ( 25 )$$

$$( Equation 26 )$$

$${A}_{V 10} - {A}_{V 14} = - {G}_{tx 2} + {G}_{r x 2} \qquad ( 26 )$$

$$( Equation 27 )$$

$${A}_{V 11} - {A}_{V 15} = - {G}_{tx 2} - {G}_{r x 2} \qquad ( 27 )$$

Here, when equations (25) to (27) are converted into matrix form, the amplitude differences of each set and the relative amplitude errors satisfy the relationship expressed by the following Equation (28).

$$( Equation 28 )$$

$$( \begin{matrix}{A}_{V 9} - {A}_{V 13} \\ {A}_{V 10} - {A}_{V 14} \\ {A}_{V 11} - {A}_{V 15}\end{matrix} ) = ( \begin{matrix}- 1 & 1 \\ - 1 & 1 \\ - 1 & - 1\end{matrix} ) \cdot ( \begin{matrix}{G}_{tx 2} \\ {G}_{r x 2}\end{matrix} ) \qquad ( 28 )$$

The left-hand side term of Equation (28) is the amplitude difference vector Y2 between overlapping virtual antennas V. The first term on the right-hand side of Equation (28) is the coefficient matrix A2, and the second term is the amplitude error vector X2. The amplitude difference vector Y2 is calculated from the amplitude at the peak of each beat signal. The coefficient matrix A2 is a constant matrix defined by the combination of transmission circuit 3 and reception circuit 4 for each set of virtual antennas V. That is, the compensation unit 64 obtains Gₜₓ₂ and Gᵣₓ₂, as the solution to Equation (28), as the relative amplitude error of the second transmission circuit 3_2 with respect to the first transmission circuit 3_1, and the relative amplitude error of the second reception circuit 4_2 with respect to the first reception circuit 4_1.

### Other Embodiments

The above description has explained a plurality of embodiments, but the present disclosure is not to be construed as being limited to these embodiments, and may be applied to various embodiments and combinations thereof without departing from the gist of the present disclosure.

In a modification, the diagnosis unit 66, when the foreign matter counter determines that the threshold is exceeded, that is, when it diagnoses that there is a foreign matter, may execute a response process for the foreign matter instead of, or in addition to, the notification process of S240. Specifically, the diagnosis unit 66 may execute a process to activate a heater (not shown) provided in the radar device 1. If the foreign matter is frost, the operation of the heater may remove the frost. Further, the diagnosis unit 66 may identify the antennas TX, RX affected by the foreign matter and execute a prohibition process that prohibits the use of the reception signals at the virtual antennas V belonging with those antennas TX, RX for acquiring target information. The diagnosis unit 66 may first activate the heater, and if the foreign matter is not removed thereafter, may execute the prohibition process.

In a modification, the diagnosis unit 66 may diagnose whether a peak outside the allowable error range, which is permitted according to the temperature information, in the relative amplitude error between at least one of different transmission circuits 3 and reception circuits 4, is due to a virtual image or a failure, based on the number of such peaks.

In a modification, the temperature detection unit 65 may acquire temperature information corresponding to phase information in S160. Specifically, the temperature detection unit 65 in S160 detects temperature information based on the parameter K calculated in S80. As described above, the parameter K is a parameter that changes according to temperature. That is, the temperature detection unit 65 can acquire temperature information from the correspondence between the value of parameter K and temperature, as shown in FIG. 9. This correspondence is stored in advance, for example, in a storage medium such as memory 6a. The correspondence may be stored in the form of a functional expression, table, or the like. Further, the temperature detection unit may acquire temperature information corresponding to the relative amplitude error. Since the parameter a used in the calculation of the relative amplitude error is also a value corresponding to temperature, like parameter K, the temperature detection unit 65 can acquire temperature information from the correlation between parameter a and temperature.

Note that, since the temperature information corresponding to the phase information is related to the wiring, it is a temperature relatively close to the actual temperature of the wiring. That is, the sensor temperature information and the phase temperature information are basically different due to the difference in the temperature detection location. In this embodiment, the phase temperature information is basically lower than the sensor temperature information. For example, when the external temperature of the radar device 1 is equivalent to room temperature and the sensor temperature information from a normal temperature sensor 5 is about 60° C., the phase temperature information may be a lower temperature, for example, about 40° C.

In a modification of the fourth embodiment, both the transmission antennas TX and reception antennas RX may be arranged at uneven spacing.

In a modification, the dedicated computer constituting the control unit 6 may be a sensor management ECU that integrally controls multiple types of sensors installed in a vehicle. The dedicated computer constituting the control unit 6 may be an integrated ECU that integrates driving control of the vehicle. The dedicated computer constituting the control unit 6 may be a judgment ECU that determines driving tasks in the vehicle's driving control. The dedicated computer constituting the control unit 6 may be a monitoring ECU that monitors the vehicle's driving control. The dedicated computer constituting the control unit 6 may be an evaluation ECU that evaluates the vehicle's driving control. The dedicated computer constituting the control unit 6 may be a navigation ECU that navigates the vehicle's travel route. The dedicated computer constituting the control unit 6 may be a locator ECU that estimates the vehicle's self-state quantities. The dedicated computer constituting the control unit 6 may be an actuator ECU that controls the vehicle's travel actuators. The dedicated computer constituting the control unit may be an HCU (HMI (Human Machine Interface) Control Unit) that controls information presentation in the vehicle. The dedicated computer constituting the control unit 6 may also be a computer other than the vehicle, such as an external center or mobile terminal capable of communicating with the vehicle.

In a modification, the mobile body to which the radar device 1 is applied may be, for example, an autonomous device (autonomous robot) capable of cargo transport or information collection by autonomous driving or remote driving. The autonomous device (autonomous robot) includes, for example, an autonomous vehicle. In addition to the embodiments described so far, the above embodiments and modifications may be implemented as a control device mountable on a mobile body, having at least one processor 6b and one memory 6a, and may be realized in the form of a processing circuit (for example, a processing ECU, etc.) or a semiconductor device (for example, a semiconductor chip, etc.).

What is claimed is:

1. A radar device comprising:
a plurality of transmission antennas;
a plurality of reception antennas;
a number Ns of transmission circuits connected to the transmission antennas and outputting transmission signals;
a number Nr of reception circuits connected to the reception antennas and acquiring a reception signal;
a control unit configured to process the reception signal; and
a housing unit configured to house the transmission antennas, the reception antennas, the transmission circuits, the reception circuits, and the control unit,
wherein
Ns and Nr are each integers of 2 or more,
the plurality of transmission antennas and the plurality of reception antennas are arranged such that:
(i) at least one of the plurality of transmission antennas and the plurality of reception antennas is arranged at unequal intervals;
(ii) among a group of virtual antennas assumed for each transmission antenna for the plurality of reception antennas according to a phase difference of reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets;
(iii) at least one different wiring length set is included, which is a set of virtual antennas with overlapping virtual positions and different wiring lengths; and
(iv) a total number of belonging sets, which are sets of virtual antennas belonging to at least one of the unique sets and the different wiring length set, is at least Ns+Nr−1 sets,
the control unit includes:
an error acquisition unit configured to acquire, for a plurality of reflectors, an error in at least one of phase and amplitude in at least one of between different transmitting circuits and between different receiving circuits, based on a comparison result of reflector information relating to the same reflector in the reception signals among the virtual antennas in at least Ns+Nr−1 belonging sets;
a temperature acquisition unit is configured to acquire temperature information related to internal temperature of the housing unit; and
a diagnosis unit is configured to, when the number of out-of-range reflectors, which are the reflectors for which the error acquired falls outside an allowable error range permitted according to the temperature information, is within an allowable upper limit number, diagnoses the out-of-range reflectors as virtual images, and when the number of the out-of-range reflectors exceeds the allowable upper limit number, diagnoses that at least one of the transmission circuit and the reception circuit has failed.

2. The radar device according to claim 1, wherein
the diagnosis unit executes diagnosis with respect to the error regarding at least the phase between the transmission circuits.

3. The radar device according to claim 1, wherein
the housing unit includes a radome that covers the transmission antennas and the reception antennas with respect to an outside, and
the diagnosis unit, when the number of sets of the virtual antennas for which the phase difference based on information other than the comparison result is also outside an allowable difference range is within an upper limit number of sets, suspends diagnosis that a cause of the number of out-of-range reflectors exceeding the allowable upper limit number is failure, and diagnoses that the cause is due to adhesion of foreign matter on the radome.

4. The radar device according to claim 3, wherein
the diagnosis unit outputs a notification regarding the adhesion of the foreign matter and the failure.

5. A radar device comprising:
a plurality of transmission antennas arranged at equal intervals;
a plurality of reception antennas arranged at equal intervals;
a number Ns of transmission circuits connected to the transmission antennas and outputting transmission signals;
a number Nr of reception circuits connected to the reception antennas and acquiring a reception signal;
a control unit configured to process the reception signal; and
a housing unit configured to house the transmission antennas, the reception antennas, the transmission circuits, the reception circuits, and the control unit,
wherein
Ns and Nr are each integers of 2 or more,
the plurality of transmission antennas and the plurality of reception antennas are arranged such that:
(i) among a group of virtual antennas assumed for each transmission antenna for the plurality of reception antennas according to a phase difference of reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets;
(ii) at least one different wiring length set is included, which is a set of virtual antennas with overlapping virtual positions and different wiring lengths; and
(iii) a total number of belonging sets, which are sets of virtual antennas belonging to at least one of the unique sets and the different wiring length set, is at least Ns+Nr−1 sets,
the control unit includes:
an error acquisition unit configured to acquire, for a plurality of reflectors, an error in at least one of phase and amplitude in at least one of between different transmitting circuits and between different receiving circuits, based on a comparison result of reflector information relating to the same reflector in the reception signals among the virtual antennas in at least Ns+Nr−1 belonging sets;
a temperature acquisition unit is configured to acquire temperature information related to internal temperature of the housing unit; and
a diagnosis unit is configured to, when the number of out-of-range reflectors, which are the reflectors for which the error acquired falls outside an allowable error range permitted according to the temperature information, is within an allowable upper limit number, diagnoses the out-of-range reflectors as virtual images, and when the number of the out-of-range reflectors exceeds the allowable upper limit number, diagnoses that at least one of the transmission circuit and the reception circuit has failed.

6. The radar device according to claim 5, wherein
the diagnosis unit executes diagnosis with respect to the error regarding at least the phase between the transmission circuits.

7. The radar device according to claim 5, wherein
the housing unit includes a radome that covers the transmission antennas and the reception antennas with respect to an outside, and
the diagnosis unit, when the number of sets of the virtual antennas for which the phase difference based on information other than the comparison result is also outside an allowable difference range is within an upper limit number of sets, suspends diagnosis that a cause of the number of out-of-range reflectors exceeding the allowable upper limit number is failure, and diagnoses that the cause is due to adhesion of foreign matter on the radome.

8. The radar device according to claim 7, wherein
the diagnosis unit outputs a notification regarding the adhesion of the foreign matter and the failure.

9. A radar device comprising:
a plurality of transmission antennas;
a plurality of reception antennas;
a number Ns of transmission circuits connected to the transmission antennas and outputting transmission signals;
a number Nr of reception circuits connected to the reception antennas and acquiring a reception signal;
a control unit configured to process the reception signal; and
a housing unit configured to house the transmission antennas, the reception antennas, the transmission circuits, the reception circuits, and the control unit,
wherein
Ns and Nr are each integers of 2 or more,
the plurality of transmission antennas and the plurality of reception antennas are arranged such that:
(i) at least one of the plurality of transmission antennas and the plurality of reception antennas is arranged at unequal intervals; and
(ii) among a group of virtual antennas assumed for each transmission antenna for the plurality of reception antennas according to a phase difference of reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets,
the control unit includes:
an error acquisition unit configured to acquire, for a plurality of reflectors, an error in at least one of phase and amplitude in at least one of between different transmitting circuits and between different receiving circuits, based on a comparison result of reflector information relating to the same reflector in the reception signals among the virtual antennas in at least Ns+Nr−2 unique sets;
a temperature acquisition unit is configured to acquire temperature information related to internal temperature of the housing unit; and
a diagnosis unit is configured to, when the number of out-of-range reflectors, which are the reflectors for which the error acquired falls outside an allowable error range permitted according to the temperature information, is within an allowable upper limit number, diagnoses the out-of-range reflectors as virtual images, and when the number of the out-of-range reflectors exceeds the allowable upper limit number, diagnoses that at least one of the transmission circuit and the reception circuit has failed.

10. The radar device according to claim 9, wherein
the diagnosis unit executes diagnosis with respect to the error regarding at least the phase between the transmission circuits.

11. The radar device according to claim 9, wherein
the housing unit includes a radome that covers the transmission antennas and the reception antennas with respect to an outside, and
the diagnosis unit, when the number of sets of the virtual antennas for which the phase difference based on information other than the comparison result is also outside an allowable difference range is within an upper limit number of sets, suspends diagnosis that a cause of the number of out-of-range reflectors exceeding the allowable upper limit number is failure, and diagnoses that the cause is due to adhesion of foreign matter on the radome.

12. The radar device according to claim 11, wherein
the diagnosis unit outputs a notification regarding the adhesion of the foreign matter and the failure.

13. A radar device comprising:
a plurality of transmission antennas arranged at equal intervals;
a plurality of reception antennas arranged at equal intervals;
a number Ns of transmission circuits connected to the transmission antennas and outputting transmission signals;
a number Nr of reception circuits connected to the reception antennas and acquiring a reception signal;
a control unit configured to process the reception signal; and
a housing unit configured to house the transmission antennas, the reception antennas, the transmission circuits, the reception circuits, and the control unit,
wherein
Ns and Nr are each integers of 2 or more,
the plurality of transmission antennas and the plurality of reception antennas are arranged such that, among a group of virtual antennas assumed for each transmission antenna for the plurality of reception antennas according to a phase difference of reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets,
the control unit includes:
an error acquisition unit configured to acquire, for a plurality of reflectors, an error in at least one of phase and amplitude in at least one of between different transmitting circuits and between different receiving circuits, based on a comparison result of reflector information relating to the same reflector in the reception signals among the virtual antennas in at least Ns+Nr−2 unique sets;
a temperature acquisition unit is configured to acquire temperature information related to internal temperature of the housing unit; and
a diagnosis unit is configured to, when the number of out-of-range reflectors, which are the reflectors for which the error acquired falls outside an allowable error range permitted according to the temperature information, is within an allowable upper limit number, diagnoses the out-of-range reflectors as virtual images, and when the number of the out-of-range reflectors exceeds the allowable upper limit number, diagnoses that at least one of the transmission circuit and the reception circuit has failed.

14. The radar device according to claim 13, wherein
the diagnosis unit executes diagnosis with respect to the error regarding at least the phase between the transmission circuits.

15. The radar device according to claim 13, wherein
the housing unit includes a radome that covers the transmission antennas and the reception antennas with respect to an outside, and
the diagnosis unit, when the number of sets of the virtual antennas for which the phase difference based on information other than the comparison result is also outside an allowable difference range is within an upper limit number of sets, suspends diagnosis that a cause of the number of out-of-range reflectors exceeding the allowable upper limit number is failure, and diagnoses that the cause is due to adhesion of foreign matter on the radome.

16. The radar device according to claim 15, wherein
the diagnosis unit outputs a notification regarding the adhesion of the foreign matter and the failure.
